(19) United States
(12) Patent Application Publication
(10) Pub. No.: US 2007/0145337 A1
(43) Pub. Date: Jun. 28, 2007

(54) Photochromic 2H-naphthopyrans

(76) Inventor: Anu Chopra, Pittsburgh, PA (US)

Correspondence Address: PPG Industries, Inc.;Law Department - Intellectual Property, One PPG Place - 39th Floor, Pittsburgh, PA, 15272-0001, US

(21) Appl. No.: 11/317,577

(22) Filed: Dec. 23, 2005

(51) Int. Cl. G02B 5/23; F21V 9/00

(52) U.S. Cl. 252/586

(57) ABSTRACT

Described are photochromic 2H-naphtho[1,2-b]pyrans characterized by two adjacent moderate to strong electron donor substituents at the 7 and 8 positions, a moderate to strong electron withdrawing substituent at the 5 position, and at the 2 position, one substituent that is a weak electron donor and another substituent that is a weak to moderate electron donor. An optional substituent is located at the 6 position and each of the positions may have reactive substituents that enable the photochromic material to be more compatible with the host polymer. The selection and placement of the aforementioned substituents being done on the naphthopyran to demonstrate a lambda max of less than 490 nanometers in the Photochromic Performance Test. The selection and placement of substituents also enables the balancing of photochromic properties, such as the intensity, as measured in the Photochromic Performance Test. Also described are polymeric organic host materials that contain or that are coated with such naphthopyrans or combinations thereof with complementary photochromic compounds to produce photochromic articles such as ophthalmic lenses.

### BACKGROUND OF THE INVENTION

Various non-limiting embodiments of the present disclosure relate to photochromic materials comprising 2H-naphtho[1,2-b]pyrans. Other non-limiting embodiments of the present disclosure relate to photochromic articles, compositions, and methods of making the photochromic articles, wherein the photochromic articles and compositions comprise the photochromic materials described herein.

Many conventional photochromic materials, such as, for example, naphthopyrans, can undergo a transformation from one state to another in response to the absorption of electromagnetic radiation. For example, many conventional photochromic materials are capable of transforming between a first “clear” or “bleached” ground state and a second “colored” activated state in response to the absorption of certain wavelengths of electromagnetic radiation (or “actinic radiation”). As used herein the term “actinic radiation” refers to electromagnetic radiation that is capable of causing a photochromic material to transform from one form or state to another. The photochromic material may then revert back to the clear ground state in response to thermal energy in the absence of actinic radiation.

Photochromic articles and compositions that contain two or more photochromic materials, for example photochromic lenses for eyewear applications, generally display clear and colored states that correspond to the photochromic material(s) that they contain. Thus, for example, eyewear lenses that contain yellow and blue photochromic materials can transform from a clear state to a gray colored state upon exposure to actinic radiation, such as certain wavelengths found in sunlight, and can revert back to the clear state in the absence of such radiation.

When utilized in photochromic articles and compositions, conventional photochromic materials are typically incorporated into a host polymer matrix by one of imbibing, blending and/or bonding. For example, one or more photochromic materials may be intermixed with a polymeric material or precursor thereof, and thereafter the photochromic composition may be formed into the photochromic article or, alternatively, the photochromic composition may be coated on a surface of an optical element as a thin film or layer. As used herein, the term “photochromic composition” refers to a photochromic material in combination with one or more other materials, which may or may not be photochromic material(s). Alternatively, the photochromic material may be imbibed into a pre-formed article or coating.

In some situations, it may be desirable to control the wavelength of the photochromic material in the activated state. In other situations, it may also be desirable to control the intensity of the activated photochromic material. It may further be desirable to modify the compatibility of such a photochromic material with the host polymer into which it is incorporated. Modifications to such activated state properties may be done, for example, to match the same properties of complementary photochromic materials. Modification of the compatibility of the photochromic materials may be done to enable the use of such compounds in various applications with hydrophilic or hydrophobic coating compositions, thin films or in rigid to flexible plastic matrices.

Accordingly, for various applications it may be advantageous to develop photochromic materials having a desirable activated wavelength. It may also be beneficial to develop such photochromic materials having a desirable intensity. It may further be favorable to develop these photochromic materials with reactive substituents that may enable the photochromic materials to be incorporated into a variety of host polymers.

### SUMMARY OF THE INVENTION

Various non-limiting embodiments disclosed herein relate to photochromic materials. In one non-limiting embodiment, the photochromic material is a 2H-naphtho[1,2-b]pyran represented by the following graphic formula I in which the numbers 1-10 identify the ring atoms: 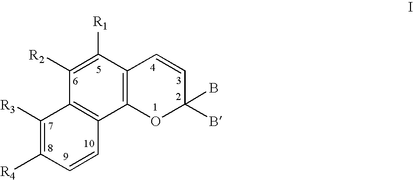
wherein:

(a) R₁ is a moderate to strong electron withdrawing group;

(b) R₂ is hydrogen, an electron withdrawing group or an electron donating group;

(c) R₃ and R₄ are each moderate to strong electron donating groups; and

(d) B is a weak electron donating group and B′ is a weak to moderate electron donating group provided that said naphthopyran demonstrates a lambda max visible of less than 490 nanometers (nm) in the Photochromic Performance Test described herein Example 7.

Another non-limiting embodiment relates to photochromic articles combining a substrate and a photochromic amount of the naphthopyran of graphic formula I according to the various non-limiting embodiments disclosed herein.

### DETAILED DESCRIPTION OF THE INVENTION

As used in this specification and the appended claims, the articles “a,” “an,” and “the” include plural referents unless expressly and unequivocally limited to one referent.

Additionally, for the purposes of this specification, unless otherwise indicated, all numbers expressing quantities of ingredients, reaction conditions, and other properties or parameters used in the specification are to be understood as being modified in all instances by the term “about.” Accordingly, unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

As used herein, the term “photochromic” means having an absorption spectrum for at least visible radiation that varies in response to absorption of at least actinic radiation. Further, as used herein, the term “photochromic material” means any substance that is adapted to display photochromic properties, i.e., adapted to have an absorption spectrum for at least visible radiation that varies in response to absorption of at least actinic radiation.

The present invention discloses what types of substituents and where they may be placed on the naphthopyran in order to control the wavelength demonstrated by these 2H-naphtho[1,2-b]pyrans in the visible spectrum. The selection of placement of substituents has also been unexpectedly found to affect the intensity of the activated photochromic materials. In one non-limiting embodiment, these photochromic compounds demonstrate a lambda max visible of less than 490 nm. In another non-limiting embodiment, the photochromic naphthopyrans of the present invention have an intensity that is higher than demonstrated by a comparable naphthopyran without the combination of electron donating and withdrawing substituents claimed herein. The intensity being higher as measured by higher Sensitivity levels with or without higher Optical Density @ Saturation levels. The intensity of the photochromic materials, upon exposure to actinic radiation, may be measured as the Sensitivity which is related to how fast the photochromic material activates and becomes colored and the Optical Density @ Saturation which is measured as how colored the photochromic material becomes under standard conditions such as specified in the Photochromic Performance Test described herein Example 7.

Such 2H-naphtho[1,2-b]pyrans, represented by graphic formula I, are characterized by two adjacent moderate to strong electron donor substituents at the 7 and 8 positions, a moderate to strong electron withdrawing substituent at the 5 position, and at the 2 position, one substituent that is a weak electron donor and another substituent that is a weak to moderate electron donor. The compounds of the present invention also have an optional substituent at the 6 position. The same positions may also be substituted with a reactive group having an electronic nature corresponding to the aforementioned electron donating and withdrawing types of substituents that enables the photochromic material to be more compatible with the host polymer.

In one non-limiting embodiment, the aforementioned combination of electron donor and withdrawing substituents enhances the properties related to the intensity of the resulting activated photochromic naphthopyrans that demonstrate a lambda max visible of less than 490 nanometers in the Photochromic Performance Test, described herein Example 7. In another non-limiting embodiment, the naphthopyrans of the present invention demonstrate a single absorption band corresponding to the lambda max visible of less than 490 nm. Such photochromic compounds having an enhanced intensity and demonstrating colors such as orange, yellow and yellow-green are desirable for use with complementary blue photochromic materials to produce more desirable neutral activated colors, e.g., gray and brown, as compared to comparable naphthopyrans without the claimed combination of electron donor and withdrawing substituents.

In another non-limiting embodiment, the intensity levels as measured by Sensitivity range from 0.50 to 1.00 and OD @ Saturation range from 0.50 to 2.00. In a further non-limiting embodiment, the Sensitivity levels range from 0.55 to 0.75 and the OD @ Saturation levels range from 0.59 to 1.5.

In a further non-limiting embodiment, the photochromic compounds of the present invention demonstrate a desirable Fade Half Life (“T_{1/2}”) described herein Example 7. In one non-limiting embodiment, the T_{1/2} is less than 200 seconds. In another non-limiting embodiment, the T_{1/2} ranges from 60 to 170 seconds. In a further non-limiting embodiment, the T_{1/2} ranges from 70 to 150 seconds. In a still further non-limiting embodiment, the T_{1/2} ranges from 70 to 100 seconds.

The relative strength of electron donor groups to be used as potential substituents is frequently described by Hammett Sigma values (specifically σₚ values). A tabular listing of σₚ constants for a variety of substituents can be found in Exploring QSAR, Hydrophobic, Electronic, and Steric Constants C. Hansch, A. Leo, and D. Hoekman, Eds., published by The American Chemical Society, Washington, D.C., 1995, which disclosure is incorporated herein by reference. Examples of strong electron donors, defined herein as having a Hammett σₚ value of between −1.0 and −0.5, that may be used at the 7- and 8-positions include amino, monoalkylamino, dialkylamino, morpholino, and piperidino. Examples of moderate electron donors, defined herein as having a σₚ value of between −0.49 and −0.20 that may be used at the 7- and 8-positions include ethoxy, methoxy, and p-aminophenyl. Examples of such moderate electron donors that may be used at one of the two 2-positions of the pyrano portion of the naphthopyran include an aryl group substituted at the para-position with groups, such as ethoxy, methoxy or p-aminophenyl. Examples of weak electron donors, defined herein as having a Hammett σₚ value of between −0.01 and −0.19 that may be used at the two 2-positions of the pyrano portion of the naphthopyran include aryl which includes phenyl and naphthyl, and tolyl. Examples of moderate to strong electron withdrawers, defined herein as having a Hammett σₚ value of greater than 0.40, e.g., from 0.41 to 1.00, include carboxyl, esters such as —COOY and aldehydes such as —C(O)H. All of the aforementioned electron donor or withdrawing groups may be used as optional substituents at the 6-position.

As discussed above, the photochromic materials according to various non-limiting embodiments disclosed herein, may comprise a reactive substituent. A detailed description of reactive substituents is disclosed in paragraphs [0008] to

and [0017] to [0072] in patent application Ser. No. 11/102,280 filed Apr. 8, 2005, which disclosure is incorporated herein by reference. The reactive substituents of the present invention for groups R₁; R₂; R₃; R₄; B and/or B′ have been selected on the basis of their electron donating or withdrawing properties.

As used herein, the term “reactive substituent” means an arrangement of atoms, wherein a portion of the arrangement comprises a reactive moiety or residue thereof. According to various non-limiting embodiments disclosed herein, the reactive substituent further comprises a linking group connecting the reactive moiety to the photochromic naphthopyran. As used herein, the term “moiety” means a part or portion of an organic molecule that has a characteristic chemical property. As used herein, the term “reactive moiety” means a part or portion of an organic molecule that may react to form one or more bonds with an intermediate in a polymerization reaction, or with a polymer into which it has been incorporated. As used herein, the phrase “intermediate in the polymerization reaction” means any combination of two or more host monomer units that are capable of reacting to form one or more bonds to additional host monomer unit(s) to continue a polymerization reaction or, alternatively, reacting with a reactive moiety of the reactive substituent on the photochromic material. For example, in one non-limiting embodiment the reactive moiety may react as a co-monomer in the polymerization reaction. Alternatively, but not limiting herein, the reactive moiety may react with the intermediate as a nucleophile or electrophile. As used herein, the term “host monomer or oligomer” means the monomeric or oligomeric material(s) into which the photochromic materials of the present disclosure may be incorporated. As used herein, the terms “oligomer” or “oligomeric material” refer to a combination of two or more monomer units that are capable of reacting with an additional monomer unit(s). As used herein, the term “linking group” means one or more group(s) or chain(s) of atoms that connect the reactive moiety to the photochromic naphthopyran. As used herein, the term “residue of a reactive moiety” means that which remains after a reactive moiety has been reacted with either a protecting group or an intermediate in a polymerization reaction. As used herein, the term “protecting group” means a group of atoms removably bonded to the reactive moiety that prevents the reactive moiety from participating in a reaction until the group is removed.

In one non-limiting embodiment, the reactive moiety comprises a polymerizable moiety. As used herein, the term “polymerizable moiety” means a part or portion of an organic molecule that can participate as a co-monomer in a polymerization reaction of a host monomer or oligomer. In another non-limiting embodiment, the reactive moiety comprises a nucleophilic moiety that reacts to form a bond with an electrophilic moiety on either the intermediate in the polymerization reaction or the host polymer. Alternatively, in another non-limiting embodiment, the reactive moiety comprises an electrophilic moiety that reacts to form a bond with a nucleophilic moiety on either the intermediate in the polymerization reaction or the host polymer. As used herein, the term “nucleophilic moiety” means an atom or grouping of atoms that is electron rich. As used herein, the term “electrophilic moiety” means an atom or grouping of atoms that is electron poor. It is appreciated by one skilled in the art that nucleophilic moieties can react with electrophilic moieties, for example to form a covalent bond therebetween.

As discussed above, in one non-limiting embodiment, the photochromic material comprises a photochromic naphthopyran represented by graphic formula I and a reactive substituent bonded to the photochromic naphthopyran. For example, according to various non-limiting embodiments disclosed herein, a reactive substituent may be bonded to the photochromic naphthopyran by replacing a hydrogen on one of the rings of the naphtho-portion of the photochromic naphthopyran with a reactive substituent. Alternatively or in addition, a reactive substituent may be bonded to photochromic naphthopyran by replacing a hydrogen on the B′ group of the photochromic naphthopyran with a reactive substituent. The number of reactive substituents bonded to the naphthopyran of the present invention may vary widely. In one non-limiting embodiment, there are 6 or less reactive substituents bonded to the naphthopyran; in another non-limiting embodiment, there are 4 or less; in a further non-limiting embodiment there are one or two reactive substituents.

The reactive substituent that may be present as at least one of R₁; R₂; R₃; R₄; B and B′, according to the provisos included herein, comprise group R which is independently represented by one of:
-A-D-E-G-J;
-A-G-E-G-J;
-A-D-G-J;
-A-G-J and
-A-D-J.

Non-limiting examples of structures for each -A- according to various non-limiting embodiments of the present invention include: —C(O)— and —CH₂—.

Non-limiting examples of structures for each -D- according to various non-limiting embodiments of the present invention include: a diamine residue or a derivative thereof, wherein a first amine nitrogen of said diamine residue forms a bond with -A- and a second amine nitrogen of said diamine residue forms a bond with -E-, -G-, or -J; or an amino alcohol residue or a derivative thereof, wherein an amine nitrogen of said amino alcohol residue forms a bond with -A- and an alcohol oxygen of said amino alcohol residue forms a bond with -E-, -G-, or -J; or said amine nitrogen of said amino alcohol residue forms a bond with -E-, -G-, or -J, and said alcohol oxygen of said amino alcohol residue forms a bond with -A-.

When -D- is a diamine residue, non-limiting examples of a diamine residue include an aliphatic diamine residue, a cyclo aliphatic diamine residue, a diazacycloalkane residue, an azacyclo aliphatic amine residue, a diazacrown ether residue, and an aromatic diamine residue.

When -D- is an amino alcohol residue, non-limiting examples of an amino alcohol residue include an aliphatic amino alcohol residue, a cyclo aliphatic amino alcohol residue, an azacyclo aliphatic alcohol residue, a diazacyclo aliphatic alcohol residue, and an aromatic amino alcohol residue.

Non-limiting examples of structures for each -E- according to various non-limiting embodiments of the present invention include: a dicarboxylic acid residue or a derivative thereof, wherein a first carbonyl group of said dicarboxylic acid residue forms a bond with -G- or -D-, and a second carbonyl group of said dicarboxylic acid residue forms a bond with -G. When -E- is a dicarboxylic acid residue, non-limiting examples of a dicarboxylic acid residue include: aliphatic dicarboxylic acid residue, cycloaliphatic dicarboxylic acid residue and an aromatic dicarboxylic acid residue.

Non-limiting examples of structures for -G- according to various non-limiting embodiments of the present disclosure include polyalkyleneglycol residues and polyol residues and derivatives thereof. When -G- is a polyol residue, a first polyol oxygen of said polyol residue forms a bond with -A-, -D- or -E-, and a second polyol oxygen of said polyol residue forms a bond with -E- or -J. Non-limiting examples of suitable polyalkyleneglycol residues include the structure: —[(OC₂H₄)ₓ(OC₃H₆)_{y}(OC₄H₈)_{z}]—O—, wherein x, y, and z, are each independently a number between 0 and 50, and the sum of x, y, and z ranges from 1 to 50. Non-limiting examples of suitable polyol residues include aliphatic polyol residues, cyclo aliphatic polyol residues, and aromatic polyol residues.

In the various non-limiting embodiments of the present disclosure, J is a group comprising a reactive moiety or residue thereof; or -J is hydrogen, provided that if -J is hydrogen, -J is bonded to an oxygen of group -D- or -G-, forming a reactive moiety. Non-limiting examples of suitable -J groups include acryl, crotyl, methacryl, 2-(methacryloxy)ethylcarbamyl, 2-(methacryloxy)ethoxycarbonyl, 4-vinylphenyl, vinyl, 1-chlorovinyl, and epoxy.

The substituent R₁ comprises the reactive substituent provided that R₁ is the group —C(O)OR; or R₁ is the group R provided that -A- is —C(O)— and -D- is an amino alcohol residue wherein an amine nitrogen of said amino alcohol residue forms a bond with -E-, -G-, or -J; and an alcohol oxygen of said amino alcohol residue forms a bond with -A-.

The substituent R₂ comprises the reactive substituent provided that R₂ is the group —OR; or R₂ comprises a group T independently represented by one of:
-G-E-G-J;
-D-E-G-J;
-D-G-J;
-G-J and
-D-J;
wherein -E-, -G- and -J are the same as defined hereinabove and -D- is an amino alcohol wherein the amine nitrogen of said amino alcohol residue forms a bond with -E-, -G- or -J.

The substituents R₃ and/or R₄ comprise the reactive substituent provided that R₃ and/or R₄ are each the group —OR, —SR, —N(R)H or —N(R)R provided that -A- is —CH₂—.

The substituent B and/or B′ comprises the reactive substituent provided that B and/or B′ is a substituted aryl or a substituted heteroaromatic group and the substituent for said aryl or heteroaromatic group is the group R or the group T.

In one non-limiting embodiment, the substituent R₁ is the group —C(O)H or —C(O)OY, wherein, Y is hydrogen, the group, —CH(R₅)Z; wherein Z is —CN, —CF₃, halo or —C(O)R₆; R₅ is hydrogen or C₁-C₆ alkyl; R₆ is hydrogen, C₁-C₆ alkyl or C₁-C₆ alkoxy; or Y is the group —R₇; R₇ is C₁-C₆ alkyl, allyl, phenyl(C₁-C₃)alkyl, mono(C₁-C₆)alkyl substituted phenyl(C₁-C₃)alkyl, mono(C₁-C₆)alkoxy substituted phenyl(C₁-C₃)alkyl, (C₁-C₆)alkoxy(C₂-C₄)alkyl, C₁-C₆ haloalkyl, or an unsubstituted, mono- or di-substituted aryl group, each of said aryl group substituents being halogen, C₁-C₆ alkyl or C₁-C₆ alkoxy. An aryl group includes, but is not limited to, phenyl, naphthyl, fluorenyl, anthracenyl and phenanthracenyl. In another non-limiting embodiment, an aryl group includes phenyl and naphthyl. Halogen or halo includes, but is not limited to, fluorine (fluoro), chlorine (chloro), bromine (bromo) and iodine (iodo). In another non-limiting embodiment, halogen includes fluorine, chlorine and bromine.

In another non-limiting embodiment, the substituent R₁ is the group —C(O)Y, wherein, Y is hydrogen, hydroxy, the group, —OCH(R₅)Z or —OR₇; Z is —CN or —C(O)R₆; R₅ is hydrogen or C₁-C₄ alkyl; R₆ is hydrogen, C₁-C₄ alkyl or C₁-C₄ alkoxy; and R₇ is C₁-C₄ alkyl, allyl, phenyl(C₁-C₂)alkyl, mono(C₁-C₄)alkyl substituted phenyl(C₁-C₂)alkyl, mono(C₁-C₄)alkoxy substituted phenyl(C₁-C₂)alkyl, (C₁-C₄)alkoxy(C₂-C₃)alkyl, C₁-C₃ chloroalkyl, C₁-C₃ fluoroalkyl, or an unsubstituted, mono- or di-substituted phenyl group, each of said phenyl group substituents being chloro, fluoro, C₁-C₃ alkyl or C₁-C₃ alkoxy.

In one non-limiting embodiment, the substituent R₂ is hydrogen, C₁-C₆ alkyl, C₁-C₆ alkoxy, an unsubstituted, mono- or di-substituted aryl group, amino, mono(C₁-C₆)alkylamino, di(C₁-C₆)alkylamino, phenylamino, mono- or di-(C₁-C₆)alkyl substituted phenylamino, mono- or di-(C₁-C₆)alkoxy substituted phenylamino, diphenylamino, mono- or di-(C₁-C₆)alkyl substituted diphenylamino, mono- or di-(C₁-C₆)alkoxy substituted diphenylamino, morpholino, piperidino, dicyclohexylamino or pyrrolidyl, said aryl substituents being C₁-C₆ alkyl, C₁-C₆ alkoxy, C₃-C₆ cycloalkyl, benzyl, amino, mono(C₁-C₆)alkylamino, di(C₁-C₆)alkylamino, dicyclohexylamino, diphenylamino, piperidino, morpholino, pyrrolidyl, pyridyl, halo, phenyl and naphthyl.

In another non-limiting embodiment, the substituent R₂ is hydrogen, C₁-C₄ alkyl, C₁-C₄ alkoxy, an unsubstituted, mono- or di-substituted phenyl group, amino, mono(C₁-C₄)alkylamino, di(C₁-C₄)alkylamino, morpholino, piperidino, dicyclohexylamino or pyrrolidyl, said phenyl substituents being C₁-C₄ alkyl, C₁-C₄ alkoxy, C₃-C₅ cycloalkyl, benzyl, amino, mono(C₁-C₆)alkylamino, di(C₁-C₆)alkylamino, piperidino, morpholino, pyrrolidyl, pyridyl, chloro, fluoro, phenyl or naphthyl.

In one non-limiting embodiment, the substituent R₃ is one of:

(i) the group, —XR₈, wherein X is oxygen or sulfur; R₈ is hydrogen, C₁-C₆ alkyl, an unsubstituted, mono- and di-substituted aryl group, phenyl(C₁-C₃)alkyl, mono(C₁-C₆)alkyl substituted phenyl(C₁-C₃)alkyl, mono(C₁-C₆)alkoxy substituted phenyl(C₁-C₃)alkyl, C₁-C₆ alkoxy(C₂-C₄)alkyl, C₃-C₇ cycloalkyl, mono(C₁-C₄)alkyl substituted C₃-C₇ cycloalkyl, C₁-C₆ haloalkyl, allyl; or R₈ is the group —CH(R₉)Q, wherein, R₉ is hydrogen or C₁-C₃ alkyl and Q is —CN, —CF₃ or —COOR₅, each of said aryl group substituents being C₁-C₆ alkyl or C₁-C₆ alkoxy;

(ii) the group, —N(R₁₀)R₁₀, wherein each R₁₀ is independently R₈, an C₁-C₆ alkylaryl group or the heteroaromatic groups furanyl, benzofuran-2-yl, benzofuran-3-yl, thienyl, benzothien-2-yl, benzothien-3-yl, dibenzofuranyl, dibenzothienyl, benzopyridyl and fluorenyl;

(i) a heterocyclic ring represented by the following graphic formula IIA: 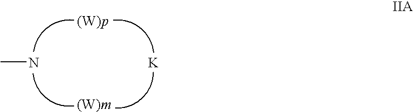
wherein each W is independently the group —CH₂—, —CH(R₁₁)—, —C(R₁₁)(R₁₁)—, —CH(aryl)-, —C(aryl)₂-, —C(R₁₁)(aryl)-, and K is the group —W—, —O—, —S—, —S(O)—, —S(O₂)—, —NH—, —NR₁₁— or —N-aryl-, wherein R₁₁ is C₁-C₆ alkyl, m is the integer 1, 2 or 3, and p is the integer 0, 1, 2 or 3 and when p is O, K is W; or

(iv) a group represented by the following graphic formula IIB or IIC: 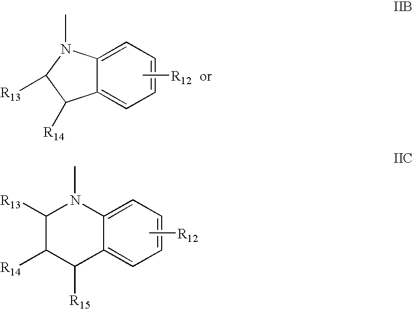
wherein R₁₂ is C₁-C₆ alkyl, C₁-C₆ alkoxy or halo, R₁₃, R₁₄ and R₁₅ are each hydrogen, C₁-C₅ alkyl, phenyl or naphthyl, or the groups R₁₃ and R₁₄ come together to form a ring of 5 to 8 carbon atoms including the ring carbon atoms.

In one non-limiting embodiment, the substituent R₄ is the same as R₃ defined hereinbefore.

In another non-limiting embodiment, the substituent R₃ is:

(i) the group, —XR₈, wherein X is oxygen; R₈ is hydrogen, C₁-C₄ alkyl, an unsubstituted, mono- and di-substituted phenyl group, phenyl(C₁-C₂)alkyl, mono(C₁-C₄)alkyl substituted phenyl(C₁-C₂)alkyl, mono(C₁-C₄)alkoxy substituted phenyl(C₁-C₂)alkyl, C₁-C₄ alkoxy(C₂-C₃)alkyl, C₃-C₅ cycloalkyl, mono(C₁-C₄)alkyl substituted C₃-C₅ cycloalkyl, C₁-C₄ chloroalkyl, C₁-C₄ fluoroalkyl, allyl; or R₈ is the group —CH(R₉)Q, wherein, R₉ is hydrogen or C₁-C₂ alkyl and Q is —CN or —COOR₅, each of said phenyl group substituents being C₁-C₄ alkyl or C₁-C₄ alkoxy;

(ii) the group —N(R₁₀) R₁₀ wherein each R₁₀ is R₈;

(iii) a heterocyclic ring represented by graphic formula IIA: wherein each W is independently the group —CH₂—, —CH(R₁₁)—, —C(R₁₁)(R₁)—, —CH(aryl)-, —C(aryl)₂-, —C(R₁₁)(aryl)-, and K is the group —W—, —O—, —NH—, —NR₁₁— or —N-aryl-, wherein R₁₁ is C₁-C₄ alkyl, m is the integer 1, 2 or 3, and p is the integer 0, 1, 2 or 3 and when p is O, K is W.

In another non-limiting embodiment, the substituent R₄ is the same as R₃ defined hereinbefore.

In one non-limiting embodiment, the substituent B is aryl or tolyl. In another non-limiting embodiment, the substituent B is phenyl or tolyl.

In one non-limiting embodiment, the substituent B′ is one of:

(i) an unsubstituted, mono-, di-, or tri-substituted aryl group; or an unsubstituted, mono- or di-substituted heteroaromatic group, said heteroaromatic group being pyridyl, furanyl, benzofuran-2-yl, benzofuran-3-yl, thienyl, benzothien-2-yl, benzothien-3-yl, dibenzofuranyl, dibenzothienyl, carbazoyl, benzopyridyl, indolinyl or fluorenyl, wherein said aryl and heteroaromatic substituents are each independently being: hydroxy, aryl, mono(C₁-C₆)alkoxyaryl, di(C₁-C₆)alkoxyaryl, mono(C₁-C₆)alkylaryl, di(C₁-C₆)alkylaryl, p-aminoaryl, haloaryl, C₃-C₇ cycloalkylaryl, C₃-C₇ cycloalkyl, C₃-C₇ cycloalkyloxy, C₃-C₇ cycloalkyloxy(C₁-C₆)alkyl, C₃-C₇ cycloalkyloxy(C₁-C₆)alkoxy, aryl(C₁-C₆)alkyl, aryl(C₁-C₆)alkoxy, aryloxy, aryloxy(C₁-C₆)alkyl, aryloxy(C₁-C₆)alkoxy, mono- and di-(C₁-C₆)alkylaryl(C₁-C₆)alkyl, mono- and di-(C₁-C₆)alkoxyaryl(C₁-C₆)alkyl, mono- and di-(C₁-C₆)alkylaryl(C₁-C₆)alkoxy, mono- and di-(C₁-C₆)alkoxyaryl(C₁-C₆)alkoxy, C₁-C₆ alkyl, C₁-C₆ haloalkyl, C₁-C₆ alkoxy, mono(C₁-C₆)alkoxy(C₁-C₄)alkyl, acryloxy, methacryloxy, halogen or a group —C(O)R₁₆, wherein R₁₆ is —OR₁₇, wherein R₁₇ is allyl, C₁-C₆ alkyl, phenyl, mono(C₁-C₆)alkyl substituted phenyl, mono(C₁-C₆)alkoxy substituted phenyl, phenyl(C₁-C₃)alkyl, mono(C₁-C₆)alkyl substituted phenyl(C₁-C₃)alkyl, mono(C₁-C₆)alkoxy substituted phenyl(C₁-C₃)alkyl, C₁-C₆ alkoxy(C₂-C₄)alkyl or C₁-C₆ haloalkyl;

(ii) an unsubstituted or mono-substituted group, said group being pyrazolyl, imidazolyl, pyrazolinyl, imidazolinyl, pyrrolinyl, phenothiazinyl, phenoxazinyl, phenazinyl or acridinyl, each of said substituents being C₁-C₁₂ alkyl, C₁-C₁₂ alkoxy, phenyl or halogen;

(iii) a mono-substituted phenyl, said phenyl having a substituent located at the para position, wherein the substituent is: a dicarboxylic acid residue or derivative thereof, a diamine residue or derivative thereof, an amino alcohol residue or derivative thereof, a polyol residue or derivative thereof, —CH₂—, —(CH₂)ₜ— or [O—(CH₂)ₜ]ₖ—, wherein t is an integer 2, 3, 4, 5 or 6 and k is an integer from 1 to 50, the substituent being connected to an aryl group on another photochromic material;

(iv) a group represented by one of graphic formula IID and IIE: 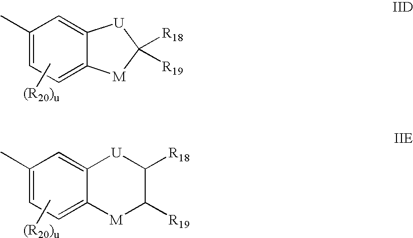
wherein U is —CH₂— or —O— and M is —O—, each R₂₀ being independently chosen for each occurrence from C₁-C₁₂ alkyl, C₁-C₁₂alkoxy, hydroxy, and halogen, R₁₈ and R₁₉ each being independently hydrogen or C₁-C₁₂ alkyl, and u is an integer ranging from 0 to 2; or

(v) a group represented by graphic formula IIF: 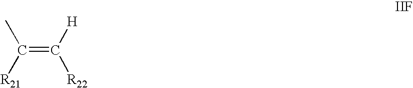
wherein R₂₁ is hydrogen or C₁-C₁₂ alkyl, and R₂₂ is an unsubstituted, mono-, or di-substituted group chosen from naphthyl, phenyl, furanyl, and thienyl, wherein the substituents are C₁-C₁₂ alkyl, C₁-C₁₂ alkoxy or halogen.

In another non-limiting embodiment, the substituent B′ is one of:

(i) an unsubstituted, mono-, di-, or tri-substituted phenyl; or an unsubstituted, mono- or di-substituted heteroaromatic group, said heteroaromatic group being furanyl, benzofuran-2-yl, thienyl, benzothien-2-yl, dibenzofuranyl, or carbazoyl, wherein each of said phenyl and heteroaromatic substituents are each independently being hydroxy, C₁-C₃ alkyl, C₁-C₃ chloroalkyl, C₁-C₃ fluoroalkyl, C₁-C₃ alkoxy, mono(C₁-C₃)alkoxy(C₁-C₃)alkyl, p-aminophenyl, fluoro and chloro;

(ii) a mono-substituted phenyl, said phenyl having a substituent located at the para position, wherein the substituent is: —CH₂—, —(CH₂)ₜ—, or —[O—(CH₂)ₜ]ₖ—, wherein t is an integer 2, 3, 4, 5 or 6 and k is an integer from 1 to 50, the substituent being connected to an aryl group on another photochromic material;

(iii) a group represented by graphic formula IID wherein U is —CH₂—, and M is —O—, each R₂₀ independently being for each occurrence C₁-C₃ alkyl or C₁-C₃ alkoxy, each R₁₈ and R₁₉ are independently being hydrogen or C₁-C₃ alkyl, and u is the integer 0 or 1.

Compounds represented by graphic formula I, which have the substituents R₁, R₂, R₃, R₄, B and B′ described hereinbefore, may be prepared by following Reactions A through D. Methods for preparing compounds represented by graphic formula I wherein R₃ and/or R₄ is an amino group(s) are included in Reaction E. Methods for the preparation of compounds wherein R₁ is the polymerizable polyalkoxylated group -A-G-J and R₂, B and/or B′ are the group G-J are described in column 8, line 42 to column 20, line 15 in U.S. Pat. No. 6,113,814, which disclosure is incorporated herein by reference. Methods for the preparation of compounds having the reactive substituent R are described in the aforereferenced paragraphs of patent application Ser. No. 11/102,280 filed Apr. 8, 2005.

Compounds represented by graphic formula V, VA, or VB are either purchased or prepared by Friedel-Crafts methods shown in Reaction A using an appropriately substituted or unsubstituted benzoyl chloride of graphic formula IV with a substituted or unsubstituted benzene compound of graphic formula III, which may be commercially available. See the publication Friedel-Crafts and Related Reactions, George A. Olah, Interscience Publishers, 1964, Vol. 3, Chapter XXXI (Aromatic Ketone Synthesis), and “Regioselective Friedel-Crafts Acylation of 1,2,3,4-Tetrahydroquinoline and Related Nitrogen Heterocycles: Effect on NH Protective Groups and Ring Size” by Ishihara, Yugi et al, J. Chem. Soc., Perkin Trans. 1, pages 3401 to 3406, 1992.

In Reaction A, the compounds represented by graphic formulae III and IV are dissolved in a solvent, such as carbon disulfide, methylene chloride or dimethyl sulfoxide, and reacted in the presence of a Lewis acid, such as aluminum chloride or tin tetrachloride, to form the corresponding substituted benzophenone represented by graphic formula V (VA in Reaction B or VB in Reaction C). R′ and R″ represent possible substituents, as described hereinbefore with respect to graphic formula I.

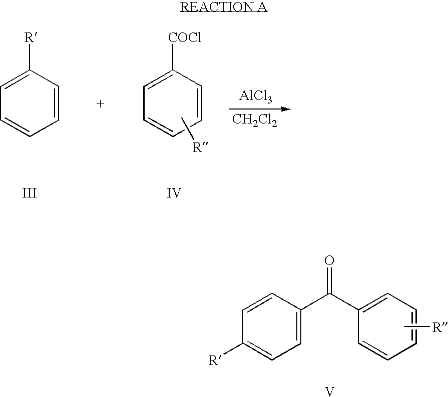

In Reaction B, the substituted or unsubstituted ketone represented by graphic formula VA, in which B and B′ may represent groups other than substituted or unsubstituted phenyl, as shown in graphic formula V, is reacted with sodium acetylide in a suitable solvent, such as anhydrous tetrahydrofuran (THF) or dimethylformamide (DMF), to form the corresponding propargyl alcohol represented by graphic formula VI. Propargyl alcohols having B or B′ groups other than substituted and unsubstituted phenyl may be prepared from commercially available ketones or ketones prepared via reaction of an acyl halide with a substituted or unsubstituted benzene, naphthalene or heteroaromatic compound. Propargyl alcohols having a B or B′ group represented by graphic formula IIF may be prepared by the methods described in U.S. Pat. No. 5,274,132, column 2, lines 40 to 68, which disclosure is incorporated herein by reference.

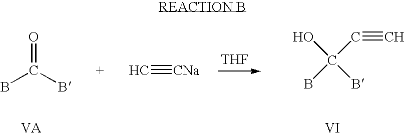

In Reaction C, a substituted benzophenone or benzaldehyde represented by graphic formula VB is reacted with an ester of succinic acid such as dimethyl succinate represented by graphic formula VII. Addition of the reactants to a solvent, e.g., toluene, containing potassium t-butoxide or sodium hydride as the base yields the Stobbe condensation half ester represented by graphic formula VIII. A mixture of cis and trans half esters forms which then undergoes cyclization in the presence of acetic anhydride to form an acetoxynaphthalene. This product is hydrolyzed in methanol with hydrochloric acid to form the carbomethoxynaphthol represented by graphic formula X.

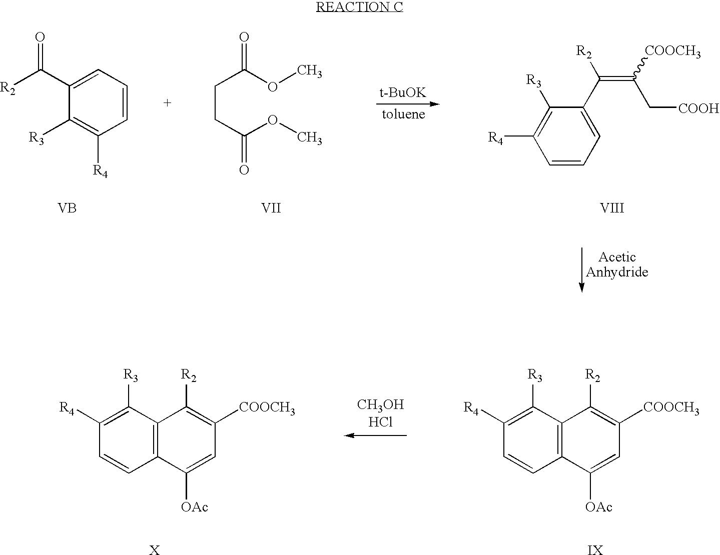

In Reaction D, the carbomethoxynaphthol represented by graphic formula X is coupled with a propargyl alcohol represented by graphic formula VI in the presence of a catalytic amount of an acid, e.g., dodecylbenzene sulfonic acid (DBSA), in a solvent, e.g., chloroform, to produce the naphthopyran represented by graphic formula IA.

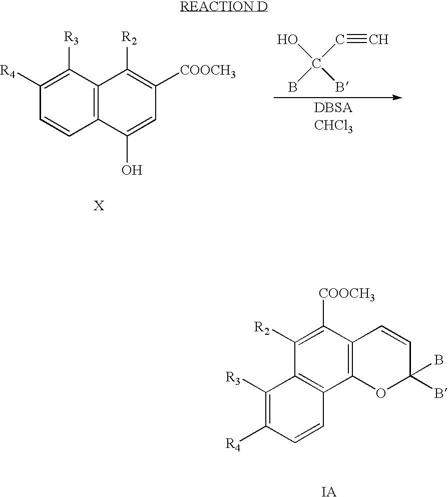

Reaction E along with the procedures described in Reactions C and D are followed to produce amino substituted naphthopyrans. In Reaction E, the ketone represented by graphic formula VC is reacted with a lithium salt of an amine represented by graphic formula XI in a solvent such as tetrahydrofuran (THF) to produce the amino substituted ketone represented by graphic formula XII. In order to prepare a material having an amino substituent at both the R₃ and R₄ positions, an additional fluorine would be located at the R₃ position on the ketone represented by graphic formula VC. An alternative method for substituting with amino groups is to use bromo in place of fluoro and a palladium catalyst, as known to those skilled in the art. Treatment of compound XII with dimethyl succinate to produce the corresponding ester, followed by cyclization with acetic anhydride and subsequent methanolysis as described in Reaction C produces the corresponding amino substituted naphthol. The amino substituted naphthol is then coupled with propargyl alcohol as described in Reaction D to produce amino substituted naphthopyrans.

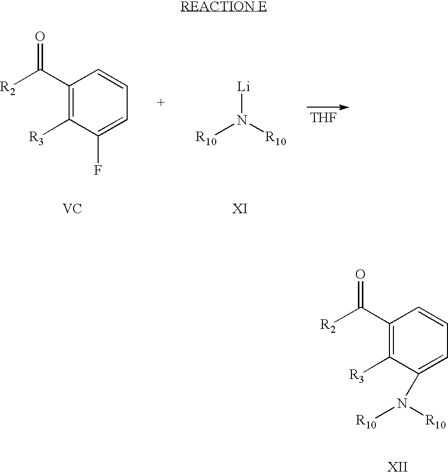

Non-limiting examples of photochromic materials comprising naphthopyrans according to the various embodiments of the present disclosure include at least one of:
(a) 2-(4-methoxyphenyl)-2-phenyl-5-methoxycarbonyl-7,8-dimethoxy-2H-naphtho[1,2-b]pyran;
(b) 2-(4-methylphenyl)-2-phenyl-5-methoxycarbonyl-7,8-dimethoxy-2H-naphtho[1,2-b]pyran;
(c) 2,2-diphenyl-5-methoxycarbonyl-7,8-dimethoxy-2H-naphtho[1,2-b]pyran;
(d) 2-(2-(9,9-dimethyl)-fluorenyl)-2-phenyl-5-methoxycarbonyl-7,8-dimethoxy-2H-naphtho[1,2-b]pyran;
(e) 2,2-diphenyl-5-[2-(2-hydroxyethoxy)ethoxycarbonyl]-7,8-dimethoxy-2H-naphtho[1,2-b]pyran; and
(f) 2,2-diphenyl-5-[2-(2-(2-methacryloxyethyl)carbamyloxyethoxy)-ethoxycarbonyl]-7,8-dimethoxy-2H-naphtho[1,2-b]pyran.

The photochromic materials of the present disclosure, for example photochromic materials comprising the photochromic naphthopyran with or without a reactive substituent bonded to the photochromic naphthopyran, wherein the reactive substituent has the structure as set forth herein, may be used in those applications in which photochromic materials may be employed, such as, optical elements, for example, an ophthalmic element, a display element, a window, a mirror, an active liquid crystal cell element, and a passive liquid crystal cell element. As used herein, the term “optical” means pertaining to or associated with light and/or vision. As used herein, the term “ophthalmic” means pertaining to or associated with the eye and vision. As used herein, the term “display” means the visible or machine-readable representation of information in words, numbers, symbols, designs or drawings. Non-limiting examples of display elements include screens, monitors, and security elements, such as security marks. As used herein, the term “window” means an aperture adapted to permit the transmission of radiation therethrough. Non-limiting examples of windows include aircraft and automotive windshields, automotive and aircraft transparencies, e.g., T-roofs, sidelights and backlights, filters, shutters, and optical switches. As used herein, the term “mirror” means a surface that specularly reflects a large fraction of incident light. As used herein, the term “liquid crystal cell” refers to a structure containing a liquid crystal material that is capable of being ordered. One non-limiting example of a liquid crystal cell element is a liquid crystal display.

In certain non-limiting embodiments, the photochromic materials of the present disclosure may be used in an ophthalmic element, such as, corrective lenses, including single vision or multi-vision lenses, which may be either segmented or non-segmented multi-vision lenses (such as, but not limited to, bifocal lenses, trifocal lenses and progressive lenses), non-corrective lenses, a magnifying lens, a protective lens, a visor, goggles, and a lens for an optical instrument, such as a camera or telescope lens. In other non-limiting embodiments, the photochromic materials of the present disclosure may be used in plastic films and sheets, textiles, and coatings.

The photochromic materials according to various non-limiting embodiments disclosed herein may be incorporated into an organic material, such as a polymeric, oligomeric, or monomeric material, which may be used, for example and without limitation, to form articles of manufacture, such as optical elements, and coatings that can be applied to other substrates. As used herein the term “incorporated into” means physically and/or chemically combined with. Thus, the photochromic materials according to various non-limiting embodiments disclosed herein may be physically and/or chemically combined with at least a portion of an organic material. As used herein the terms “polymer” and “polymeric material” refers to homopolymers and copolymers (e.g., random copolymers, block copolymers, and alternating copolymers), as well as blends and other combinations thereof. Further, it is contemplated that the photochromic materials according to various non-limiting embodiments disclosed herein may each be used alone, in combination with other photochromic materials according to various non-limiting embodiments disclosed herein, or in combination with other appropriate complementary conventional photochromic materials. For example, the photochromic materials according to various non-limiting embodiments disclosed herein may be used in conjunction with other complementary conventional photochromic materials having an activated absorption maxima within the range of 300 to 1000 nanometers. The complementary conventional photochromic materials may include other polymerizable or compatabilized photochromic materials.

The present disclosure also contemplates photochromic compositions comprising a polymeric material and a photochromic material according to the various non-limiting embodiments discussed herein. As used herein, the term “photochromic composition” refers to a photochromic material in combination with another material, which may or may not be a photochromic material. In certain non-limiting examples of the photochromic compositions according to various non-limiting embodiments of the present disclosure, the photochromic material is incorporated into at least a portion of the polymeric material. For example, and without limitation, the photochromic materials disclosed herein may be incorporated into a portion of the polymeric material, such as by bonding to a portion of the polymeric material, for example by co-polymerizing the photochromic material with a portion of the polymeric material; or blending with the polymeric material. As used herein, the term “blended” or “blending” mean that the photochromic material is intermixed or intermingled with at least a portion of an organic material, such as the polymeric material, but not bonded to the organic material. As used herein, the terms “bonded” or “bonding” mean that the photochromic material is linked to a portion of an organic material, such as the polymeric material, or a precursor thereof. For example, in certain non-limiting embodiments, the photochromic material may be bonded to a portion of an organic material through a reactive substituent (such, but not limited to, those reactive substituents discussed above).

According to one non-limiting embodiment wherein the organic material is a polymeric material, the photochromic material may be incorporated into at least a portion of the polymeric material or at least a portion of the monomeric material or oligomeric material from which the polymeric material is formed. For example, photochromic materials according to various non-limiting embodiments disclosed herein that have a reactive substituent may be bonded to an organic material such as a monomer, oligomer, or polymer having a group with which a reactive moiety may be reacted, or the reactive moiety can be reacted as a co-monomer in the polymerization reaction from which the organic material is formed, for example, in a co-polymerization process. As used, herein, the term “co-polymerized with” means that the photochromic material is linked to a portion of the polymeric material by reacting as a co-monomer in the polymerization reaction of the host monomers that result in the polymeric material. For example, photochromic materials according to various non-limiting embodiments herein that have a reactive substituent that comprises a polymerizable moiety may react as a co-monomer during the polymerization of the host monomers.

Polymeric materials suitable for the various non-limiting embodiments of the present disclosure includes, but is not limited to polyacrylates, polymethacrylates, poly(C₁-C₁₂) alkylated methacrylates, polyoxy(alkylene methacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), poly(vinylpyrrolidone), poly((meth)acrylamide), poly(dimethyl acrylamide), poly((meth)acrylic acid), thermoplastic polycarbonates, polyesters, polyurethanes, polyureaurethanes, polythiourethanes, poly(ethylene terephthalate), polystyrene, poly(alpha-methylstyrene), copoly(styrene-methylmethacrylate), copoly(styrene-acrylonitrile), polyvinylbutyral, and polymers of members of the group consisting of polyol(allyl carbonate)monomers, mono-functional acrylate monomers, mono-functional methacrylate monomers, polyfunctional acrylate monomers, polyfunctional methacrylate monomers, diethylene glycol dimethacrylate monomers, diisopropenyl benzene monomers, alkoxylated polyhydric alcohol monomers, and diallyidene pentaerythritol monomers. In certain non-limiting embodiments of the photochromic compositions of the present disclosure, the polymeric material comprises a homopolymer or a copolymer of monomer(s) chosen from acrylates, methacrylates, methyl methacrylate, ethylene glycol bis methacrylate, ethoxylated bisphenol A dimethacrylate, vinyl acetate, vinylbutyral, urethane, thiourethane, diethylene glycol, bis(allyl carbonate), diethylene glycol dimethacrylate, diisopropenyl benzene, ethoxylated trimethylol propane triacrylate, and combinations thereof.

Transparent copolymers and blends of transparent polymers are also suitable host polymeric materials for the photochromic compositions according to the various non-limiting embodiments disclosed herein. For example, according to various non-limiting embodiments, the polymeric material may be an optically clear polymeric material prepared from a thermoplastic polycarbonate resin, such as the resin derived from bisphenol A and phosgene, which is sold under the trademark, LEXAN®; a polyester, such as the material sold under the trademark, MYLAR®; a poly(methyl methacrylate), such as the material sold under the trademark, PLEXIGLAS®; polymerizates of a polyol(allyl carbonate) monomer, especially diethylene glycol bis(allyl carbonate), which monomer is sold under the trademark CR-39®; and polyurea-polyurethane (polyureaurethane) polymers, which are prepared, for example, by the reaction of a polyurethane prepolymer and a diamine curing agent, a composition for one such polymer being sold under the trademark TRIVEX® by PPG Industries, Inc. (Pittsburgh, Pa., USA). Other non-limiting examples of suitable polymeric materials include polymerizates of copolymers of a polyol (allyl carbonate), e.g., diethylene glycol bis(allyl carbonate), with other copolymerizable monomeric materials, such as, but not limited to: copolymers with vinyl acetate; copolymers with a polyurethane having terminal diacrylate functionality; and copolymers with aliphatic urethanes, the terminal portion of which contain allyl or acryloyl functional groups. Still other suitable polymeric materials include, without limitation, poly(vinyl acetate), polyvinylbutyral, polyurethane, polythiourethanes, polymers chosen from diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol bismethacrylate monomers and ethoxylated trimethylol propane triacrylate monomers, cellulose acetate, cellulose propionate, cellulose butyrate, cellulose acetate butyrate, polystyrene and copolymers of styrene with methyl methacrylate, vinyl acetate, acrylonitrile, and combinations thereof. According to one non-limiting embodiment, the polymeric material may be an optical resin sold by PPG Industries, Inc. under the CR-designation, e.g., CR-307, CR-407, and CR-607.

Various non-limiting embodiments disclosed herein provide photochromic articles comprising a substrate and a photochromic material according to any of the non-limiting embodiments discussed above connected to a portion of the substrate. As used herein, the term “connected to” means associated with, either directly or indirectly through another material or structure. In one non-limiting embodiment, the photochromic articles of the present disclosure may be an optical element, for example, but not limited to, an ophthalmic element, a display element, a window, a mirror, an active liquid crystal cell element, and a passive liquid crystal cell element. In certain non-limiting embodiments, the photochromic article is an ophthalmic element, for example, but not limited to, corrective lenses, including single vision or multi-vision lenses, which may be either segmented or non-segmented multi-vision lenses (such as, but not limited to, bifocal lenses, trifocal lenses and progressive lenses), non-corrective lenses, a magnifying lens, a protective lens, a visor, goggles, and a lens for an optical instrument.

For example and without limitation, the photochromic materials disclosed herein may be connected to at least a portion of the substrate, such as by bonding the photochromic materials to at least a portion of the material from which the substrate is made, for example, by co-polymerizing or otherwise bonding the photochromic materials with the substrate material; blending the photochromic materials with the substrate material; or coating the photochromic materials on at least a portion of a surface of the substrate. Alternatively, with the photochromic material may be connected to at least a portion of the substrate such as through an intermediate coating, film or layer.

According to various non-limiting embodiments disclosed herein wherein the substrate of the photochromic article comprises a polymeric material, the photochromic material may be connected to at least a portion of the substrate by incorporating the photochromic material into at least a portion of the polymeric material of the substrate, or at least a portion of the oligomeric or monomeric material from which the substrate is formed. For example, according to one non-limiting embodiment, the photochromic material may be incorporated into the polymeric material of the substrate by the cast-in-place method. Additionally or alternatively, the photochromic material may be connected with at least a portion of the polymeric material of the substrate by imbibition. Imbibition and the cast-in-place method are discussed below.

For example, according to one non-limiting embodiment, the substrate comprises a polymeric material and a photochromic material is bonded to at least a portion of the polymeric material. According to another non-limiting embodiment, the substrate comprises a polymeric material and a photochromic material is blended with at least a portion of the polymeric material. According to another non-limiting embodiment, the substrate comprises a polymeric material and a photochromic material is co-polymerized with at least a portion of the polymeric material. Non-limiting examples of polymeric materials that are useful in forming the substrates according to various non-limiting embodiments disclosed herein are set forth above in detail.

According to other non-limiting embodiments, the photochromic material may be connected to at least a portion of the substrate of the photochromic article as part of an at least partial coating that is connected to at least a portion of a substrate. According to this non-limiting embodiment, the substrate may be a polymeric substrate or an inorganic substrate (such as, but not limited to, a glass substrate). Further, the photochromic material may be incorporated into at least a portion of the coating composition prior to application of the coating composition to the substrate, or alternatively, a coating composition may be applied to the substrate, at least partially set, and thereafter the photochromic material may be imbibed into at least a portion of the coating. As used herein, the terms “set” and “setting” include, without limitation, curing, polymerizing, cross-linking, cooling, and drying.

For example, in one non-limiting embodiment of the present disclosure, the photochromic article may comprise an at least partial coating of a polymeric material connected to at least a portion of a surface thereof. According to this non-limiting embodiment, the photochromic material may be blended with at least a portion of the polymeric material of the at least partial coating, or the photochromic material may be bonded to at least a portion of the polymeric material of the at least partial coating. According to one specific non-limiting embodiment, the photochromic material may be co-polymerized with at least a portion of the polymeric material of the at least partial coating.

The at least partial coating comprising a photochromic material may be directly connected the substrate, for example, by directly applying a coating composition comprising a photochromic material to at least a portion of a surface of the substrate, and at least partially setting the coating composition. Additionally or alternatively, the at least partial coating comprising a photochromic material may be connected to the substrate, for example, through one or more additional coatings. For example, while not limiting herein, according to various non-limiting embodiments, an additional coating composition may be applied to at least a portion of the surface of the substrate, at least partially set, and thereafter the coating composition comprising a photochromic material may be applied over the additional coating and at least partially set.

Non-limiting examples of additional coatings and films that may be used in conjunction with the optical elements disclosed herein include primer coatings and films; protective coatings and films, including transitional coatings and films and abrasion resistant coatings and films; anti-reflective coatings and films; conventional photochromic coating and films; polarizing coatings and films; and combinations thereof. As used herein, the term “protective coating or film” refers to coatings or films that may prevent wear or abrasion, provide a transition in properties from one coating or film to another, protect against the effects of polymerization reaction chemicals and/or protect against deterioration due to environmental conditions, such as moisture, heat, ultraviolet light, oxygen, etc.

Non-limiting examples of primer coatings and films that may be used in conjunction with various non-limiting embodiments disclosed herein include coatings and films comprising coupling agents, partial hydrolysates of coupling agents, and mixtures thereof. As used herein, the term “coupling agent” means a material having a group capable of reacting, binding and/or associating with a group on one or more surfaces. In one non-limiting embodiment, a coupling agent may serve as a molecular bridge at the interface of two or more surfaces that may be similar or dissimilar surfaces. Coupling agents, in another non-limiting embodiment, may be monomers, oligomers, and/or polymers. Such materials include, but are not limited to, organo-metallics such as silanes, titanates, zirconates, aluminates, zirconium aluminates, hydrolysates thereof and mixtures thereof. As used herein, the phrase “partial hydrolysates of coupling agents” means that some to all of the hydrolyzable groups on the coupling agent are hydrolyzed.

As used herein, the term “transitional coating and film” means a coating or film that aids in creating a gradient in properties between two coatings or films, or a coating and a film. For example, although not limiting herein, a transitional coating may aid in creating a gradient in hardness between a relatively hard coating and a relatively soft coating.

As used herein, the term “abrasion resistant coating and film” refers to a coating of a protective polymeric material that demonstrates a resistance to abrasion that is greater than a standard reference material, e.g., a polymer made of CR-39® monomer available from PPG Industries, Inc., as tested in a method comparable to ASTM F-735 Standard Test Method for Abrasion Resistance of Transparent Plastics and Coatings Using the Oscillating Sand Method. Non-limiting examples of abrasion resistant coatings include abrasion-resistant coatings comprising organosilanes, organosiloxanes, abrasion-resistant coatings based on inorganic materials such as silica, titania and/or zirconia, organic abrasion-resistant coatings of the type that are ultraviolet light curable, oxygen barrier-coatings, UV-shielding coatings, and combinations thereof.

Non-limiting examples of antireflective coatings and films include a monolayer, multilayer or film of metal oxides, metal fluorides, or other such materials, which may be deposited onto the articles disclosed herein or a film, for example, through vacuum deposition, sputtering, or some other method. Non-limiting examples of conventional photochromic coatings and films include, but are not limited to, coatings and films comprising conventional photochromic materials. Non-limiting examples of polarizing coatings and films include, but are not limited to, coatings and films comprising dichroic compounds that are known in the art.

As discussed above, according to various non-limiting embodiments, these coatings and films may be applied to the substrate prior to applying the at least partial coating comprising a photochromic material according to various non-limiting embodiments disclosed herein. Alternatively or additionally, these coatings may be applied to the substrate after applying the at least partial coating comprising a photochromic material, for example, as an overcoating on the at least partial coating comprising a photochromic material. For example, while not limiting herein, according to various other non-limiting embodiments, the aforementioned coatings may be connected to at least a portion of the same surface of a substrate in the following order from the surface: primer, photochromic, transitional, abrasion resistant, polarizing film or coating, antireflective, and abrasion resistant; primer, photochromic, transitional, abrasion resistant, and antireflective; or photochromic, transitional, and polarizing; or primer, photochromic, and polarizing; or primer, photochromic, and antireflective. Further, the aforementioned coating may be applied to both surfaces of the substrate.

The present disclosure also contemplates various methods of making photochromic articles comprising connecting a photochromic material, according to the various non-limiting embodiments disclosed herein, to at least a portion of a substrate. For example, in one non-limiting embodiment wherein the substrate comprises a polymeric material, connecting the photochromic material to at least a portion of the substrate may comprise blending the photochromic material with at least a portion of the polymeric material of the substrate. In another non-limiting embodiment, connecting the photochromic material to at least a portion of the substrate may comprise bonding the photochromic material to at least a portion of the polymeric material of the substrate. For example, in one non-limiting embodiment, connecting the photochromic material to at least a portion of the substrate may comprise co-polymerizing the photochromic material with at least a portion of the polymeric material of the substrate. Non-limiting methods of connecting photochromic materials to a polymeric material include, for example, mixing the photochromic material into a solution or melt of a polymeric, oligomeric, or monomeric material, and subsequently at least partially setting the polymeric, oligomeric, or monomeric material. It will be appreciated by those skilled in the art that, according to this non-limiting embodiment, in the resultant photochromic composition, the photochromic materials may be blended with the polymeric material (i.e., intermixed with but not bonded to) or bonded to the polymeric material. For example, if the photochromic material contains a polymerizable group that is compatible with the polymeric, oligomeric, or monomer material, during setting of the organic material the photochromic material can be reacted with at least a portion thereof to bond the photochromic material thereto.

In another non-limiting embodiment, connecting the photochromic material to at least a portion of the substrate may comprise imbibing the photochromic material with at least a portion of the polymeric material of the substrate. According to this non-limiting embodiment, the photochromic material may be caused to diffuse into the material, for example, by immersing a polymeric material in a solution containing the photochromic material, with or without heating. Thereafter, the photochromic material may be bonded to the polymeric material as discussed above. In another non-limiting embodiment, connecting the photochromic material to at least a portion of the substrate may comprise a combination of two or more of blending, bonding (for example, by co-polymerizing), and imbibing the photochromic material to/with at least a portion of the polymeric material of the substrate.

According to one non-limiting embodiment, wherein the substrate comprises a polymeric material, incorporating the photochromic material with at least a portion of a substrate comprises a cast-in-place method. According to this non-limiting embodiment, the photochromic material may be mixed with a polymeric solution or melt, or other oligomeric and/or monomeric solution or mixture, which is subsequently cast into a molding having a desired shape and at least partially set to form the substrate. Further, although not required according to this non-limiting embodiment, a photochromic material can be bonded to the polymeric material.

According to another non-limiting embodiment, wherein the substrate comprises a polymeric material, connecting the photochromic material to at least a portion of a substrate comprises in-mold casting. According to this non-limiting embodiment, a coating composition comprising the photochromic material, which may be a liquid coating composition or a powder coating composition, is applied to the surface of a mold and at least partially set. Thereafter, a polymer solution or melt, or oligomer or monomeric solution or mixture is cast over the coating and at least partially set. After setting, the substrate with the coating is removed from the mold.

According to still another non-limiting embodiment, wherein the substrate comprises a polymeric material or an inorganic material such as glass, connecting the photochromic material to at least a portion of a substrate comprises applying an at least partial coating or lamination comprising the photochromic material to at least a portion of the substrate. Non-limiting examples of suitable coating methods include spin coating, spray coating (e.g., using a liquid or powder coating), curtain coating, roll coating, spin and spray coating, and over-molding. For example, according to one non-limiting embodiment, the photochromic material may be connected to the substrate by over-molding. According to this non-limiting embodiment, a coating composition comprising the photochromic material (which may be a liquid coating composition or a powder coating composition as previously discussed) is applied to a mold and the substrate is then placed into the mold such that the substrate contacts the coating causing it to spread over at least a portion of the surface of the substrate. Thereafter, the coating composition is at least partially set and the coated substrate is removed from the mold. Alternatively, over-molding may be done by placing the substrate into a mold such that an open region is defined between the substrate and the mold, and thereafter injecting a coating composition comprising the photochromic material into the open region. Thereafter, the coating composition can be at least partially set and the coated substrate is removed from the mold.

According to yet another non-limiting embodiment, a film comprising the photochromic material may be adhered to a portion of the substrate, with or without an adhesive and/or the application of heat and pressure. Thereafter, if desired, a second substrate may be applied over the first substrate and the two substrates may be laminated together (i.e., by the application of heat and pressure) to form an element wherein the film comprising the photochromic material is interposed between the two substrates. Methods of forming films comprising a photochromic material may include, for example and without limitation, combining a photochromic material with a polymeric solution or oligomeric solution or mixture, casting or extruding a film therefrom, and, if required, at least partially setting the film. Additionally or alternatively, a film may be formed (with or without a photochromic material) and imbibed with the photochromic material (as discussed above).

Further, it will be appreciated by those skilled in the art that the photochromic compositions, photochromic articles, and photochromic coating compositions according to various non-limiting embodiments disclosed herein may further comprise other additives that aid in the processing and/or performance of the composition. For example, and without limitation, such additives may include complementary photochromic materials, photoinitiators, thermal initiators, polymerization inhibitors, solvents, light stabilizers (such as, but not limited to, ultraviolet light absorbers and light stabilizers, such as hindered amine light stabilizers (HALS)), heat stabilizers, mold release agents, rheology control agents, leveling agents (such as, but not limited to, surfactants), free radical scavengers, or adhesion promoters (such as hexanediol diacrylate and coupling agents).

Each of the photochromic materials described herein may be used in amounts (or in a ratio) such that a substrate or a polymeric material to which the photochromic material is associated, i.e., blended, co-polymerized or otherwise bonded, coated and/or imbibed, exhibits a desired resultant color, e.g., substantially clear and colorless when the photochromic material is in the closed form and substantially colored when activated by actinic radiation and the photochromic material is in the open form.

The amount of the photochromic naphthopyrans of the present disclosure to be connected to or incorporated into a coating composition, polymeric material, substrate, photochromic composition, and/or photochromic articles is not critical provided that a sufficient amount is used to produce the desired optical effect. Generally, such amount may be described as a “photochromic amount”. The particular amount of photochromic material used may depend on a variety of factors such as, the absorption characteristics of the photochromic material used, the intensity of color desired upon irradiation thereof, and the method used to incorporate or apply the photochromic material.

The relative amounts of the aforesaid photochromic materials used in the various methods of the non-limiting embodiments of the present disclosure will vary widely and depend, in part, upon the relative intensities of the color of the activated species of such materials, the ultimate color desired, the molar absorption coefficient (or “extinction coefficient”) for actinic radiation, and the method of application to the polymeric material or substrate. Generally, the amount of total photochromic material incorporated into or connected to a polymeric material or substrate may range from about 0.05 to about 5.0 milligrams per square centimeter of the surface to which the photochromic material is incorporated into or connected to. The amount of photochromic material incorporated into or connected to a coating composition may range from 0.1 to 90 weight percent based on the weight of the coating composition. The amount of photochromic material incorporated into, i.e., blended with, co-polymerized with, or bonded to, a host polymer photochromic composition or photochromic article, such as by a in cast-in-place type method, may range from 0.01 to 50 weight percent based on the weight of the polymeric composition or photochromic article.

### EXAMPLES OF THE INVENTION

The following examples illustrate various non-limiting embodiments of the compositions and methods within the present disclosure and are not restrictive of the invention as otherwise described herein.

### Example 1

### Step 1

Potassium t-butoxide (47.4 grams) was weighed into a 1-liter reaction flask equipped with a mechanical stirrer, placed under a nitrogen atmosphere and 400 milliliters (mL) of toluene was added. A mixture of 2,3-dimethoxybenzaldehyde (49.8 grams) and dimethylsuccinate (54.3 grams) in 200 mL of toluene was added to the reaction mixture at reflux temperatures over a 30-minute time period accompanied by vigorous stirring. The reaction mixture was heated at reflux for 120 minutes. After cooling the reaction mixture to room temperature, it was poured into 500 mL of water and the toluene layer separated. The aqueous layer was extracted twice with ether (300 mL, each time), and acidified with concentrated hydrochloric acid (approximately 40 mL). A brownish oily solid was obtained from the aqueous layer by extracting twice with ethyl acetate (300 mL, each time). The organic layers were combined, washed with a saturated sodium chloride solution (400 mL) and dried over anhydrous sodium sulfate. Removal of the solvent by rotary evaporation yielded 82 grams of a brownish oily solid. A mass spectrum of this product showed it to have a mass profile consistent with 4-(2,3-dimethoxyphenyl)-3-methoxycarbonyl-3-butenoic acid (as a mixture of E and Z isomers). This material was not purified further but was used directly in the next step.

### Step 2

The product of Step 1 containing the E and Z isomers of 4-(2,3-dimethoxyphenyl)-3-methoxycarbonyl-3-butenoic acid (82 grams) was placed in a reaction flask and 120 mL of acetic anhydride was added. The reaction mixture was heated to the reflux temperature and kept at the reflux temperature for 2 hours. Afterwards, the reaction mixture was cooled to room temperature and then to 0° C. The majority of the acetic anhydride was removed under reduced pressure to yield viscous brown oil. The brown oil was added to a reaction flask containing 400 mL of ethyl acetate and then 500 mL of water was added. Solid sodium carbonate was added to the biphasic mixture until bubbling ceased. The resulting layers were separated and the aqueous layer was extracted twice with ethyl acetate (200 mL) each time. The organic layers were combined, washed with saturated sodium chloride solution (400 mL) and dried over anhydrous sodium sulfate. The solvent (ethyl acetate) was removed by rotary evaporation to yield 77 grams of a brown solid. A mass spectrum of this product showed it to have a mass profile consistent with 2-methoxycarbonyl-4-acetoxy-7,8-dimethoxy-naphthalene. This material was not purified further but was used directly in the next step.

### Step 3

2-Methoxycarbonyl-4-acetoxy-7,8-dimethoxy-naphthalene from Step 2 (75 grams), 250 mL of methanol, and 4 mL of concentrated hydrochloric acid were added to a 1 liter reaction flask and heated to the reflux temperature and maintained at that temperature for 4 hours under a nitrogen atmosphere. The reaction mixture was cooled to room temperature and then at 0° C. The solvent was then removed under reduced pressure to yield a viscous brown oil (62 grams). A mass spectrum of this product showed it to have a mass profile consistent with 2-methoxycarbonyl-4-hydroxy-7,8-dimethoxynaphthalene. This material was not purified further but was used directly in the next step.

### Step 4

2-Methoxycarbonyl-4-hydroxy-7,8-dimethoxynaphthalene from Step 3 (5.3 grams), 1-(4-methoxyphenyl)-1-phenyl-2-propyn-1-ol (4.4 grams, the product of Example 5, Step 1 of U.S. Pat. No. 5,458,814, which example is hereby specifically incorporated by reference herein), dodecylbenzene sulfonic acid (about 20 milligrams), and 200 mL of methylene chloride were combined in a reaction vessel and stirred at ambient temperature for 4 hours. The reaction mixture was washed with saturated sodium bicarbonate (200 mL), and then the solvent was removed by rotary evaporation. The resulting brown solid was purified by flash column chromatography, and subsequently the product obtained was purified by crystallization from ether to yield 3 grams of a yellowish-white solid. A nuclear magnetic resonance (NMR) analysis showed the product to have a structure consistent with 2-(4-methoxyphenyl)-2-phenyl-5-methoxycarbonyl-7,8-dimethoxy-2H-naphtho[1,2-b]pyran.

### Example 2

The process of Step 4, Example 1 was followed except that 1-(4-methylphenyl)-1-phenyl-2-propyn-1-ol (7.65 grams) was used instead of 1-(4-methoxyphenyl)-1-phenyl-2-propyn-1-ol, 11.2 grams of 2-methoxycarbonyl-4-hydroxy-7,8-dimethoxynaphthalene was used, and 300 mL of methylene chloride were used. The reaction mixture was washed twice with saturated sodium bicarbonate (300 mL each time), and then the solvent was removed by rotary evaporation. The resulting brown solid was purified by flash column chromatography, and subsequently the product obtained was purified by crystallization from ether to yield 5.6 grams of a yellow solid. An NMR analysis showed the product to have a structure consistent with 2-(4-methylphenyl)-2-phenyl-5-methoxycarbonyl-7,8-dimethoxy-2H-naphtho[1,2-b]pyran.

### Example 3

The process of Step 4 of Example 1 was followed except that 1,1-diphenyl-2-propyn-1-ol was used instead of 1-(4-methoxyphenyl)-1-phenyl-2-propyn-1-ol, 9.2 grams of 2-methoxycarbonyl-4-hydroxy-7,8-dimethoxynaphthalene was used, and 200 mL of methylene chloride were used. The reaction mixture was washed with saturated sodium bicarbonate (300 mL), and then the solvent was removed by rotary evaporation. The resulting brown solid was purified by flash column chromatography and subsequently the product obtained was purified by crystallization from ether to yield 3.5 grams of a yellow solid. An NMR analysis showed the product to have a structure consistent with 2,2-diphenyl-5-methoxycarbonyl-7,8-dimethoxy-2H-naphtho[1,2-b]pyran.

### Example 4

### Step 1

1-(2-(9,9-Dimethyl)-fluorenyl)-1-phenyl-2-propyn-1-ol was prepared following the procedure described by K. D. Belfield, et al “Synthesis of New Two-Photon Absorbing Fluorene Derivatives via Cu-Mediated Ullmann Condensations” J. Org. Chem., Vol 65, No 15, pp 4475-4481, 7/28/2000, which procedure is incorporated herein by reference. Fluorene was methylated at the 9-position using potassium hydroxide and methyl iodide in dimethyl sulfoxide followed by the Friedel-Crafts reaction with benzoyl chloride as described in Reaction A herein followed by reaction with sodium acetylide in dimethylformamide as described in Reaction B herein.

### Step 2

The process of Step 4 of Example 1 was followed except that the product of Step 1 (2.15 grams) was used instead of 1-(4-methoxyphenyl)-1-phenyl-2-propyn-1-ol, 3.4 grams of 2-methoxycarbonyl-4-hydroxy-7,8-dimethoxynaphthalene was used, and 100 mL of methylene chloride was used. The reaction mixture was washed with saturated sodium bicarbonate (300 mL), and then the solvent was removed by rotary evaporation. The resulting brown solid was purified by flash column chromatography, and subsequently the product obtained was purified by crystallization from ether to yield 2.3 grams of a yellow solid. An NMR analysis showed the product to have a structure consistent with 2-(2-(9,9-dimethyl)-fluorenyl)-2-phenyl-5-methoxycarbonyl-7,8-dimethoxy-2H-naphtho[1,2-b]pyran.

### Example 5

### Step 1

2-Methoxycarbonyl-4-hydroxy-7,8-dimethoxynaphthalene (33 grams, prepared in Step 3 of Example 1) was dissolved in 100 mL of hot methanol in a 1-liter reaction flask. A solution comprising 50 mL of 50% sodium hydroxide in 200 mL of water was added to the reaction flask and the resulting brown solution was heated at reflux temperature under a nitrogen atmosphere for two hours. The reaction mixture was cooled to room temperature and then added dropwise with stirring to a mixture of 120 mL concentrated hydrochloric acid in 300 mL of water. A brown solid precipitated out and was filtered and subsequently dried. A mass spectrum of this product showed it to have a mass profile consistent with 4-hydroxy-7,8-dimethoxy-2-naphthoic acid. This material was not purified further but was used directly in the next step.

### Step 2

The product of Step 1 (5.7 grams) was weighed into a 250 mL reaction flask and 51 mL of diethylene glycol followed by 10 drops of concentrated sulfuric acid was added. The reaction mixture was heated at 115° C. under a nitrogen atmosphere for approximately 4 hours. After cooling to room temperature, the reaction mixture was poured slowly into 600 ml of water which was vigorously stirring to yield brown oil separating out of the reaction mixture. The oil was extracted three times with methylene chloride (200 mL, each time). The organic layers were combined, washed with 200 mL of water and then 200 mL of saturated sodium chloride solution and dried over anhydrous sodium sulfate. The solvent (methylene chloride) was removed by rotary evaporation to yield 7.5 grams of brown oil. A mass spectrum of this product showed it to have a mass profile consistent with 2-[2-(2-hydroxyethoxy)-ethoxy]-carbonyl-4-hydroxy-7,8-dimethoxy-naphthalene. This material was not purified further but was used directly in the next step.

### Step 3

The process of Step 4 of Example 1 was followed except that 1,1-diphenyl-2-propyn-1-ol (9.0 grams) was used instead of 1-(4-methoxyphenyl)-1-phenyl-2-propyn-1-ol, 7.5 grams of the product of Step 2 was used, and 100 mL of chloroform was used. The resulting reaction mixture was washed with saturated sodium bicarbonate (300 mL), and then the solvent was removed by rotary evaporation. The resulting brown oil was purified by flash column chromatography to obtain 4.4 grams of reddish oil that foamed upon drying under vacuum. An NMR analysis showed the product to have a structure consistent with 2,2-diphenyl-5-[2-(2-hydroxyethoxy)-ethoxycarbonyl]-7,8-dimethoxy-2H-naphtho[1,2-b]pyran.

### Example 6

The photochromic compound of Example 5 (3.2 grams) was weighed into a 250 mL reaction flask and 80 mL of ethyl acetate followed by 2 drops of dibutyl tin dilaurate and 1.32 grams of 2-isocyanotoethyl methacrylate were added. The reaction mixture was heated at reflux temperatures under an air atmosphere for approximately 8 hours. Methanol (5 mL) was added and the reaction mixture was heated at reflux temperature for fifteen minutes. The solvents were removed by rotary evaporation. The resulting reddish residue was dissolved in a minimum amount of a 1:1 ethyl acetate/methanol mixture, and cooled to 0° C. to yield white crystals. The white crystals were filtered off and dried under vacuum. An NMR analysis showed the product to have a structure consistent with 2,2-diphenyl-5-[2-(2-(2-methacryloxyethyl)carbamyloxyethoxy)-ethoxycarbonyl]-7,8-dimethoxy-2H-naphtho[1,2-b]pyran.

### Comparative Example 1

A naphthopyran having moderate to strong electron donors as the substituents B and B′ was prepared as follows: The process of Step 4, Example 1 was followed except that 1,1-di(4-methoxyphenyl-2-propyn-1-ol (4.0 grams, the product of Example 1, Step 1 of U.S. Pat. No. 5,458,814, which example is hereby specifically incorporated by reference herein) was used instead of 1-(4-methoxyphenyl)-1-phenyl-2-propyn-1-ol, 5.6 grams of 2-methoxycarbonyl-4-hydroxy-7,8-dimethoxynaphthalene was used, and 250 mL of methylene chloride was used. The reaction mixture was washed twice with saturated sodium bicarbonate (300 mL) each time, and then the solvent was removed by rotary evaporation. The resulting brown solid was purified by flash column chromatography, and subsequently the product obtained was purified by crystallization from ether to yield 3.4 grams of a yellow solid. An NMR analysis showed the product to have a structure consistent with 2,2-di-(4-methoxyphenyl)-5-methoxycarbonyl-7,8-dimethoxy-2H-naphtho[1,2-b]pyran.

### Comparative Example 2

A naphthopyran having a weak electron withdrawing group as substituent R₁ was prepared as follows: Cyclohexyl amine (3.0 grams mL) was weighed into a 250 mL reaction flask and 40 mL of dry tetrahydrofuran was added. The reaction mixture was stirred under a nitrogen atmosphere and cooled to 0° C. using an ice bath. Methyl magnesium chloride (7 mL of a 22% by weight solution in tetrahydrofuran) was added dropwise over a 5 minute period to the reaction mixture, and the resulting viscous solution was stirred for an additional 10 minutes. The photochromic compound of Example 2, 2-(4-methylphenyl)-2-phenyl-5-methoxycarbonyl-7,8-dimethoxy-2H-naphtho[1,2-b]pyran, (2.0 grams) was dissolved in 10 mL of dry tetrahydrofuran and added dropwise to the reaction mixture at the low temperatures. The cooling bath was removed and the resulting yellow-green mixture stirred at room temperature overnight. After approximately 24 hours, the reaction was poured into a solution of concentrated hydrochloric acid (100 mL) and water (400 mL). The resulting mixture was extracted three times with 150 mL portions of methylene chloride each time. The organic layers were combined, washed with 400 mL of water and then 400 mL of saturated sodium chloride solution and dried over anhydrous sodium sulfate. The solvent was removed by rotary evaporation to yield 2.6 grams of a reddish-brown oily solid. The solid was purified by column chromatography to get 1.7 grams of red oily solid. This solid was dissolved in a minimum amount of methanol and cooled in a freezer to obtain 1.5 grams of white crystals. The white crystals were filtered off, and dried under vacuum. An NMR analysis showed the product to have a structure consistent with 2-(4-methylphenyl)-2-phenyl-5-cyclohexylaminocarbonyl-7,8-dimethoxy-2H-naphtho[1,2-b]pyran.

### Comparative Example 3

A naphthopyran having a weak electron donor group as substituent R₁ was prepared as follows: The photochromic compound of Example 3, 2,2-diphenyl-5-methoxycarbonyl-7,8-dimethoxy-2H-naphtho[1,2-b]pyran, (1.0 grams) was weighed into a 100 mL reaction flask and 40 mL of dry tetrahydrofuran followed by lithium aluminum hydride (0.9 grams) were added. The reaction mixture was stirred at room temperature under a nitrogen atmosphere for approximately 1 hour. Ethyl acetate (5 mL) was added and the reaction mixture was stirred at room temperature for fifteen minutes. The reaction mixture was poured into a solution of concentrated sulfuric acid (10 mL) and water (90 mL). The resulting mixture was extracted three times with 100 mL portions of diethyl ether each time. The organic layers were combined, washed with 200 mL of water and then 200 mL of saturated sodium chloride solution and dried over anhydrous sodium sulfate. The solvent was removed by rotary evaporation to yield 0.9 grams of an orange solid. The solid was dissolved in minimum amount of ether and cooled in a freezer to obtain white crystals. The white crystals were filtered off and dried under vacuum. An NMR analysis showed the product to have a structure consistent with 2,2-diphenyl-5-hydroxymethylene-7,8-dimethoxy-2H-naphtho[1,2-b]pyran.

### Comparative Example 4

A naphtho[1,2-b]pyran lacking a pair of adjacent substituents at the 7- and 8-positions was prepared following the procedure of Example 3, except that 2-methoxycarbonyl-4-hydroxy-7-methoxynaphthalene was used. An NMR analysis showed the product to have a structure consistent with 2,2-diphenyl-5-methoxycarbonyl-8-methoxy-2H-naphtho[1,2-b]pyran.

### Example 7

### Photochromic Performance Testing

The photochromic performance of the photochromic materials of Examples 1-6 and Comparative Examples 1-4 was tested as follows.

A quantity of the photochromic material to be tested calculated to yield a 1.5×10⁻³ molal solution was added to a flask containing 50 grams of a monomer blend of 4 parts ethoxylated bisphenol A dimethacrylate (BPA 2EO DMA), 1 part poly(ethylene glycol) 600 dimethacrylate, and 0.033 weight percent 2,2′-azobis(2-methyl propionitrile) (AIBN). The photochromic material was dissolved into the monomer blend by stirring and gentle heating. After a clear solution was obtained, it was poured into a flat sheet mold having the interior dimensions of 2.2 mm×6 inches (15.24 cm)×6 inches (15.24 cm). The mold was sealed and placed in a horizontal airflow, programmable oven programmed to increase the temperature from 40° C. to 95° C. over a 5 hour interval, hold the temperature at 95° C. for 3 hours and then lower it to 60° C. for at least 2 hours. After the mold was opened, the polymer sheet was cut using a diamond blade saw into 2 inch (5.1 cm) test squares.

The photochromic test squares prepared as described above were tested for photochromic response on an optical bench. Prior to testing on the optical bench, the photochromic test squares were exposed to 365 nm ultraviolet light for about 15 minutes to cause the photochromic material to transform from the unactivated (or bleached) state to an activated (or colored) state, and then placed in a 76° C. oven for about 15 minutes to allow the photochromic material to revert back to the bleached state. The test squares were then cooled to room temperature, exposed to fluorescent room lighting for at least 2 hours, and then kept covered (that is, in a dark environment) for at least 2 hours prior to testing on an optical bench maintained at 72° F.(22.2° C.).

The optical bench was fitted with a 250 watt Xenon arc lamp, a remote controlled shutter, a copper sulfate bath acting as a heat sink for the arc lamp, a Schott WG-320 nm cut-off filter which removes short wavelength radiation; neutral density filter(s) and a sample holder in which the square to be tested was inserted. The power output of the optical bench, i.e., the dosage of light that the sample lens would be exposed to, was calibrated with a photochromic test square used as a reference standard. This resulted in a power output ranging from 0.15 to 0.20 milliwatts per square centimeter (mW/cm2). Measurement of the power output was made using a GRASEBY Optronics Model S-371 portable photometer (Serial #21536) with a UV-A detector (Serial #22411) or comparable equipment. The UV -A detector was placed into the sample holder and the light output was measured. Adjustments to the power output were made by increasing or decreasing the lamp wattage or by adding or removing neutral density filters in the light path.

A monitoring, collimated beam of light from a tungsten lamp was passed through the square at a small angle (approximately 30°) normal to the square. After passing through the square, the light from the tungsten lamp was directed to a detector through Spectral Energy Corp. GM-200 monochromator set at the previously determined visible lambda max of the photochromic compound being measured. The output signals from the detector were processed by a radiometer.

Change in optical density (ΔOD) was determined by inserting a test square in the bleached state into the sample holder, adjusting the transmittance scale to 100%, opening the shutter from the Xenon lamp to provide ultraviolet radiation to change the test square from the bleached state to an activated (i.e., darkened) state, measuring the transmittance in the activated state, and calculating the change in optical density according to the formula: ΔOD=log(100/% Ta), where % Ta is the percent transmittance in the activated state and the logarithm is to the base 10.

The optical properties of the photochromic compounds in the test squares are reported in Table 1. The ΔOD/Min, which represents the sensitivity of the photochromic compound's response to UV light, was measured at the wavelength corresponding to the lambda max visible over the first five (5) seconds of UV exposure, then expressed on a per minute basis. The saturation optical density (OD @ Saturation) was taken under identical conditions as the ΔOD/Min, except UV exposure was continued for 15 minutes.

The lambda max visible (λₘₐₓ₋ᵥᵢₛ) is the wavelength in the visible spectrum at which the maximum absorption of the activated (colored) form of the photochromic compound in a test square occurs. The lambda max visible wavelengths reported in Table 1 were determined by testing the photochromic test square polymerizates in a Varian Cary 3 UV-Visible spectrophotometer.

The Fade Half Life (“T_{1/2}”) is the time interval in seconds for the absorbance of the activated form of the photochromic material in the test squares measured at the lambda max visible to reach one half the OD @ Saturation absorbance value at room temperature (72° F., 22.2° C.), after removal of the source of activating light.

TABLE 1
Photochromic Test Data

| Example | λₘₐₓ₋ᵥᵢₛ | Sensitivity | OD @ | T_{1/2} |
|---|---|---|---|---|
| No. | (nm) | ΔOD/Min | Saturation | (sec) |
| 1 | 485 | 0.55 | 0.59 | 70 |
| 2 | 470 | 0.63 | 0.74 | 92 |
| 3 | 461 | 0.67 | 1.04 | 121 |
| 4 | 487 | 0.61 | 1.06 | 141 |
| 5 | 461 | 0.69 | 0.88 | 80 |
| 6 | 461 | 0.56 | 0.81 | 128 |
| CE1 | 496 | 0.53 | 0.32 | 34 |
| CE2 | 476 | 0.33 | 1.29 | 443 |
| CE3 | 469 | 0.25 | 1.39 | 1017 |
| CE4 | 454 | 0.35 | 0.49 | 90 |

The data presented in Table 1 shows that the test samples prepared with each of Examples 1-6 demonstrated a lambda max visible less than 490 nm. The data also shows that each of the test samples prepared with Examples 1, 2 and 3, when compared to their respective Comparative Examples 1, 2, 3 and 4, demonstrated a higher intensity measured either as a higher Sensitivity level or both a higher Sensitivity level and a higher OD @ Saturation level, as discussed hereinafter. Examples 4, 5 and 6 also demonstrated the effects on the measured photochromic properties by using different claimed substituents. Example 4, which differed from Examples 1, 2 and 3 by a 2-position substituent, demonstrated an increase in the OD @ Saturation level and Fade Half Life, when compared to these examples. Examples 5 and 6 each differed from Example 3 by the use of different reactive substituents at the 5-position which affected intensity and Fade Half Life.

Comparative Example 1, which had moderate electron donors as substituents at both of the 2-positions and the remaining substituents were the same as Example 1, demonstrated a lambda max visible greater than 490 nm and intensity, as measured by Sensitivity and OD @ Saturation levels, less than that of Example 1. Comparative Example 2, which had a weak electron withdrawing group at the 5-position and the remaining substituents were the same as Example 2, demonstrated intensity, as measured by the Sensitivity level, less than Example 2. Comparative Example 3, which had a weak electron donor at the 5-position and the remaining substituents were the same as Example 3, demonstrated intensity, as measured by the Sensitivity level, less than Example 3. Comparative Example 4, which had a moderate electron donor group at the 8-position but not at the 7-position and the remaining substituents were the same as Example 3, demonstrated intensity, as measured by Sensitivity and OD @ Saturation levels, less than that of Example 3.

It is to be understood that the present description illustrates aspects of the invention relevant to a clear understanding of the invention. Certain aspects of the invention that would be apparent to those of ordinary skill in the art and that, therefore, would not facilitate a better understanding of the invention have not been presented in order to simplify the present description. Although the present invention has been described in connection with certain embodiments, the present invention is not limited to the particular embodiments disclosed, but is intended to cover modifications that are within the spirit and scope of the invention, as defined by the appended claims.

I claim:

1. A naphthopyran represented by the following graphic formula I: 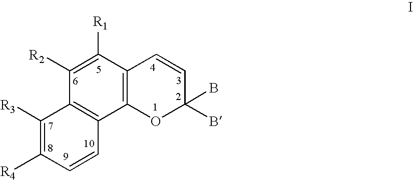
wherein,
(a) R₁ is a moderate to strong electron withdrawing group;
(b) R₂ is hydrogen, an electron withdrawing group or an electron donating group;
(c) R₃ and R₄ are each moderate to strong electron donating groups; and
(d) B is a weak electron donating group and B′ is a weak to moderate electron donating group provided that said naphthopyran demonstrates a lambda max visible of less than 490 nm in the Photochromic Performance Test.

2. The naphthopyran of claim 1 wherein at least one of R₁; R₂; R₃; R₄; B and B′ comprises a reactive substituent, wherein each reactive substituent is a group R according to the provisos included herein and is independently represented by one of:
-A-D-E-G-J;
-A-G-E-G-J;
-A-D-G-J;
-A-G-J and
-A-D-J;
wherein:
(i) each -A- is independently —C(O)— or —CH₂—;
(ii) each -D- is independently:
(a1) a diamine residue or a derivative thereof, said diamine residue being an aliphatic diamine residue, a cyclo aliphatic diamine residue, a diazacycloalkane residue, an azacyclo aliphatic amine residue, a diazacrown ether residue, or an aromatic diamine residue, wherein a first amine nitrogen of said diamine residue forms a bond with -A- and a second amine nitrogen of said diamine residue forms a bond with -E-, -G-, or -J; or
(a2) an amino alcohol residue or a derivative thereof, said amino alcohol residue being an aliphatic amino alcohol residue, a cyclo aliphatic amino alcohol residue, an azacyclo aliphatic alcohol residue, a diazacyclo aliphatic alcohol residue, or an aromatic amino alcohol residue, wherein an amine nitrogen of said amino alcohol residue forms a bond with -A- and an alcohol oxygen of said amino alcohol residue forms a bond with -E-, -G-, or -J; or said amine nitrogen of said amino alcohol residue forms a bond with -E-, -G-, or -J, and said alcohol oxygen of said amino alcohol residue forms a bond with -A-;
(iii) each -E- is independently a dicarboxylic acid residue or a derivative thereof, said dicarboxylic acid residue being an aliphatic dicarboxylic acid residue, cycloaliphatic dicarboxylic acid residue, or an aromatic dicarboxylic acid residue, wherein a first carbonyl group of said dicarboxylic acid residue forms a bond with -G- or -D-, and a second carbonyl group of said dicarboxylic acid residue forms a bond with -G-;
(iv) each -G- is independently:
(a1) —[(OC₂H₄)ₓ(OC₃H₆)_{y}(OC₄H₈)_{z}]—O—, wherein x, y, and z, are each independently a number between 0 and 50, and the sum of x, y, and z ranges from 1 to 50; or
(a2) a polyol residue or a derivative thereof, said polyol residue being an aliphatic polyol residue, a cycloaliphatic polyol residue, or an aromatic polyol residue, wherein a first polyol oxygen of said polyol residue forms a bond with -A-, -D- or -E-, and a second polyol oxygen of said polyol residue forms a bond with -E- or -J; and
(v) each -J is independently a group comprising a reactive moiety or residue thereof; or -J is hydrogen, provided that if -J is hydrogen, -J is bonded to an oxygen of group -D- or -G-, forming a reactive moiety; provided that:
(1) when R₁ comprises said reactive substituent, R₁ is the group —C(O)OR; or R₁ is the group R provided that -A- is —C(O)— and -D- is an amino alcohol residue wherein an amine nitrogen of said amino alcohol residue forms a bond with -E-, -G-, or -J; and an alcohol oxygen of said amino alcohol residue forms a bond with -A-;
(2) when R₂ comprises said reactive substituent, R₂ is the group —OR; or R₂ comprises a group T independently represented by one of:
-G-E-G-J;
-D-E-G-J;
-D-G-J;
-G-J and
-D-J;
wherein -E-, -G- and -J are the same as defined hereinabove and -D- is an amino alcohol wherein the amine nitrogen of said amino alcohol residue forms a bond with -E-, -G- or -J;
(3) when R₃ and/or R₄ comprise said reactive substituent, R₃ and/or R₄ is the group —OR, —SR, —N(R)H or —N(R)R provided that -A- is —CH₂—; and
(4) when B and/or B′ comprise said reactive substituent, B and/or B′ is a substituted aryl or a substituted heteraromatic group and said substituent for said aryl or heteraromatic group is the group R or the group T.

3. The naphthopyran of claim 2 wherein the reactive substituent R is represented by the group -A-G-J, wherein J is one of the following: acryl, crotyl, methacryl, 2-(methacryloxy)ethylcarbamyl, 2-(methacryloxy)ethoxycarbonyl, 4-vinylphenyl, vinyl, 1-chlorovinyl and epoxy.

4. The naphthopyran of claim 1 wherein:
(a) R₁ is the group —C(O)H or —C(O)OY, wherein, Y is hydrogen, the group, —CH(R₅)Z ; wherein Z is —CN, —CF₃, halo or —C(O)R₆; R₅ is hydrogen or C₁-C₆ alkyl; R₆ is hydrogen, C₁-C₆ alkyl or C₁-C₆ alkoxy; or Y is the group —R₇; R₇ is C₁-C₆ alkyl, allyl, phenyl(C₁-C₃)alkyl, mono(C₁-C₆)alkyl substituted phenyl(C₁-C₃)alkyl, mono(C₁-C₆)alkoxy substituted phenyl(C₁-C₃)alkyl, (C₁-C₆)alkoxy(C₂-C₄)alkyl, C₁-C₆ haloalkyl, or an unsubstituted, mono- or di-substituted aryl group, each of said aryl group substituents being halogen, C₁-C₆ alkyl or C₁-C₆ alkoxy;
(b) R₂ is hydrogen, C₁-C₆ alkyl, C₁-C₆ alkoxy, an unsubstituted, mono- or di-substituted aryl group, amino, mono(C₁-C₆)alkylamino, di(C₁-C₆)alkylamino, phenylamino, mono- or di-(C₁-C₆)alkyl substituted phenylamino, mono- or di-(C₁-C₆)alkoxy substituted phenylamino, diphenylamino, mono- or di-(C₁-C₆)alkyl substituted diphenylamino, mono- or di-(C₁-C₆)alkoxy substituted diphenylamino, morpholino, piperidino, dicyclohexylamino or pyrrolidyl, said aryl substituents being C₁-C₆ alkyl, C₁-C₆ alkoxy, C₃-C₆ cycloalkyl, benzyl, amino, mono(C₁-C₆)alkylamino, di(C₁-C₆)alkylamino, dicyclohexylamino, diphenylamino, piperidino, morpholino, pyrrolidyl, pyridyl, halo, phenyl and naphthyl;
(c) R₃ is one of:
(i) the group, —XR₈, wherein X is oxygen or sulfur; R₈ is hydrogen, C₁-C₆ alkyl, an unsubstituted, mono- and di-substituted aryl group, phenyl(C₁-C₃)alkyl, mono(C₁-C₆)alkyl substituted phenyl(C₁-C₃)alkyl, mono(C₁-C₆)alkoxy substituted phenyl(C₁-C₃)alkyl, C₁-C₆ alkoxy(C₂-C₄)alkyl, C₃-C₇ cycloalkyl, mono(C₁-C₄)alkyl substituted C₃-C₇ cycloalkyl, C₁-C₆ haloalkyl, allyl; or R₈ is the group, —CH(R₉)Q, wherein, R₉ is hydrogen or C₁-C₃ alkyl and Q is —CN, —CF₃ or —COOR₅, each of said aryl group substituents being C₁-C₆ alkyl or C₁-C₆ alkoxy;
(ii) the group, —N(R₁₀)R₁₀, wherein each R₁₀ is independently R₈, C₁-C₆ alkylaryl group or the heteroaromatic groups furanyl, benzofuran-2-yl, benzofuran-3-yl, thienyl, benzothien-2-yl, benzothien-3-yl, dibenzofuranyl, dibenzothienyl, benzopyridyl and fluorenyl;
(iii) a heterocyclic ring represented by the following graphic formula IIA: 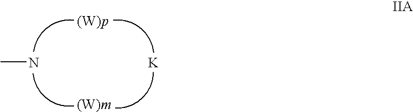
wherein each W is independently the group —CH₂—, —CH(R₁₁)—, —C(R₁₁)(R₁)—, —CH(aryl)-, —C(aryl)₂-, —C(R₁₁)(aryl)-, and K is the group —W—, —O—, —S—, —S(O)—, —S(O₂)—, —NH—, —NR₁ 1- or —N-aryl-, wherein R₁₁ is C₁-C₆ alkyl, m is the integer 1, 2 or 3, and p is the integer 0, 1, 2 or 3 and when p is O, K is W; or
(iv) a group represented by the following graphic formula IIB or IIC: 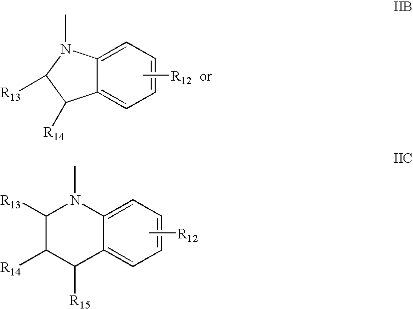
IIB IIC
wherein R₁₂ is C₁-C₆ alkyl, C₁-C₆ alkoxy or halo, R₁₃, R₁₄ and R₁₅ are each hydrogen, C₁-C₅ alkyl, phenyl or naphthyl, or the groups R₁₃ and R₁₄ come together to form a ring of 5 to 8 carbon atoms including the ring carbon atoms;
(d) R₄ is the same as R₃ defined hereinbefore;
(e) B is aryl or tolyl;
(f) B′ is one of:
(i) an unsubstituted, mono-, di-, or tri-substituted aryl group; or an unsubstituted, mono- or di-substituted heteroaromatic group, said heteroaromatic group being pyridyl, furanyl, benzofuran-2-yl, benzofuran-3-yl, thienyl, benzothien-2-yl, benzothien-3-yl, dibenzofuranyl, dibenzothienyl, carbazoyl, benzopyridyl, indolinyl or fluorenyl, wherein said aryl and heteroaromatic substituents are each independently being: hydroxy, aryl, mono(C₁-C₆)alkoxyaryl, di(C₁-C₆)alkoxyaryl, mono(C₁-C₆)alkylaryl, di(C₁-C₆)alkylaryl, haloaryl, p-aminoaryl, C₃-C₇ cycloalkylaryl, C₃-C₇ cycloalkyl, C₃-C₇ cycloalkyloxy, C₃-C₇ cycloalkyloxy(C₁-C₆)alkyl, C₃-C₇ cycloalkyloxy(C₁-C₆)alkoxy, aryl(C₁-C₆)alkyl, aryl(C₁-C₆)alkoxy, aryloxy, aryloxy(C₁-C₆)alkyl, aryloxy(C₁-C₆)alkoxy, mono- and di-(C₁-C₆)alkylaryl(C₁-C₆)alkyl, mono- and di-(C₁-C₆)alkoxyaryl(C₁-C₆)alkyl, mono- and di-(C₁-C₆)alkylaryl(C₁-C₆)alkoxy, mono- and di-(C₁-C₆)alkoxyaryl(C₁-C₆)alkoxy, C₁-C₆ alkyl, C₁-C₆ haloalkyl, C₁-C₆ alkoxy, mono(C₁-C₆)alkoxy(C₁-C₄)alkyl, acryloxy, methacryloxy, halogen or a group —C(O)R₁₆, wherein R₁₆ is —OR₁₇, wherein R₁₇ is allyl, C₁-C₆ alkyl, phenyl, mono(C₁-C₆)alkyl substituted phenyl, mono(C₁-C₆)alkoxy substituted phenyl, phenyl(C₁-C₃)alkyl, mono(C₁-C₆)alkyl substituted phenyl(C₁-C₃)alkyl, mono(C₁-C₆)alkoxy substituted phenyl(C₁-C₃)alkyl, C₁-C₆ alkoxy(C₂-C₄)alkyl or C₁-C₆ haloalkyl;
(ii) an unsubstituted or mono-substituted group, said group being pyrazolyl, imidazolyl, pyrazolinyl, imidazolinyl, pyrrolinyl, phenothiazinyl, phenoxazinyl, phenazinyl, or acridinyl, each of said substituents being C₁-C₁₂ alkyl, C₁-C₁₂ alkoxy, phenyl or halogen;
(iii) a mono-substituted phenyl, said phenyl having a substituent located at the para position, wherein the substituent is: a dicarboxylic acid residue or derivative thereof, a diamine residue or derivative thereof, an amino alcohol residue or derivative thereof, a polyol residue or derivative thereof, —CH₂—, —(CH₂)ₜ—, or —[O—(CH₂)ₜ]ₖ—, wherein t is an integer 2, 3, 4, 5 or 6 and k is an integer from 1 to 50, the substituent being connected to an aryl group on another photochromic material;
(iv) a group represented by one of graphic formulae IID and IIE: 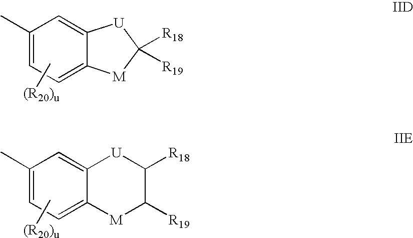
wherein U is —CH₂— or —O—, and M is —O—, each R₂₀ being independently chosen for each occurrence from C₁-C₁₂ alkyl, C₁-C₁₂alkoxy, hydroxy, and halogen, R₁₈ and R₁₉ each being independently hydrogen or C₁-C₁₂ alkyl, and u is an integer ranging from 0 to 2; and
(v) a group represented by graphic formula IIF: 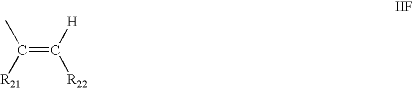
wherein R₂₁ is hydrogen or C₁-C₁₂ alkyl, and R₂₂ is an unsubstituted, mono-, or di-substituted group chosen from naphthyl, phenyl, furanyl, and thienyl, wherein the substituents are C₁-C₁₂ alkyl, C₁-C₁₂ alkoxy or halogen.

5. The naphthopyran of claim 4 wherein:
(a) R₁ is the group —C(O)Y, wherein, Y is hydrogen, hydroxy, the group, —OCH(R₅)Z or —OR₇; Z is —CN, or —C(O)R₆; R₅ is hydrogen or C₁-C₄ alkyl; R₆ is hydrogen, C₁-C₄ alkyl or C₁-C₄ alkoxy; and R₇ is C₁-C₄ alkyl, allyl, phenyl(C₁-C₂)alkyl, mono(C₁-C₄)alkyl substituted phenyl(C₁-C₂)alkyl, mono(C₁-C₄)alkoxy substituted phenyl(C₁-C₂)alkyl, (C₁-C₄)alkoxy(C₂-C₃)alkyl, C₁-C₃ chloroalkyl, C₁-C₃ fluoroalkyl, or an unsubstituted, mono- or di-substituted phenyl group, each of said phenyl group substituents being chloro, fluoro, C₁-C₃ alkyl or C₁-C₃ alkoxy;
(b) R₂ is hydrogen, C₁-C₄ alkyl, C₁-C₄ alkoxy, an unsubstituted, mono- or di-substituted phenyl group, amino, mono(C₁-C₄)alkylamino, di(C₁-C₄)alkylamino, morpholino, piperidino, dicyclohexylamino or pyrrolidyl, said phenyl substituents being C₁-C₄ alkyl, C₁-C₄ alkoxy, C₃-C₅ cycloalkyl, benzyl, amino, mono(C₁-C₆)alkylamino, di(C₁-C₆)alkylamino, piperidino, morpholino, pyrrolidyl, pyridyl, chloro, fluoro, phenyl or naphthyl;
(c) R₃ is:
(i) the group, —XR₈, wherein X is oxygen; R₈ is hydrogen, C₁-C₄ alkyl, an unsubstituted, mono- and di-substituted phenyl group, phenyl(C₁-C₂)alkyl, mono(C₁-C₄)alkyl substituted phenyl(C₁-C₂)alkyl, mono(C₁-C₄)alkoxy substituted phenyl(C₁-C₂)alkyl, C₁-C₄ alkoxy(C₂-C₃)alkyl, C₃-C₅ cycloalkyl, mono(C₁-C₄)alkyl substituted C₃-C₅ cycloalkyl, C₁-C₄ chloroalkyl, C₁-C₄ fluoroalkyl, allyl; or R₈ is the group, —CH(R₉)Q, wherein, R₉ is hydrogen or C₁-C₂ alkyl and Q is —CN or —COOR₅, each of said phenyl group substituents being C₁-C₄ alkyl or C₁-C₄ alkoxy;
(ii) the group —N(R₁₀)R₁₀, wherein R₁₀ is R₈; or
(iii) a heterocyclic ring represented by graphic formula IIA: wherein each W is independently the group —CH₂—, —CH(R₁₁)—, —C(R₁₁)(R₁)—, —CH(aryl)-, —C(aryl)₂-, —C(R₁₁)(aryl)-, and K is the group —W—, —O—, —NH—, —NR₁₁— or —N-aryl-, wherein R₁₁ is C₁-C₄ alkyl, m is the integer 1, 2 or 3, and p is the integer 0, 1, 2 or 3 and when p is O, K is W;
(d) R₄ is the same as R₃ defined hereinbefore;
(e) B is phenyl or tolyl; and
(f) B′ is one of:
(i) an unsubstituted, mono-, di-, or tri-substituted phenyl; or an unsubstituted, mono- or di-substituted heteroaromatic group, said heteroaromatic group being furanyl, benzofuran-2-yl, thienyl, benzothien-2-yl, dibenzofuranyl, or carbazoyl, wherein each of said phenyl and heteroaromatic substituents are each independently being hydroxy, C₁-C₃ alkyl, C₁-C₃ chloroalkyl, C₁-C₃ fluoroalkyl, C₁-C₃ alkoxy, mono(C₁-C₃)alkoxy(C₁-C₃)alkyl, p-aminophenyl, fluoro and chloro;
(ii) a mono-substituted phenyl, said phenyl having a substituent located at the para position, wherein the substituent is: —CH₂—, —(CH₂)ₜ—, or —[O—(CH₂)ₜ]ₖ—, wherein t is an integer 2, 3, 4, 5 or 6 and k is an integer from 1 to 50, the substituent being connected to an aryl group on another photochromic material;
(iii) a group represented by graphic formula IID:
wherein U is —CH₂—, and M is —O—, each R₂₀ independently being for each occurrence C₁-C₃ alkyl or C₁-C₃alkoxy, each R₁₈ and R₁₉ are independently being hydrogen or C₁-C₃ alkyl, and u is the integer 0 or 1.

6. A naphthopyran comprising at least one of:
(a) 2-(4-methoxyphenyl)-2-phenyl-5-methoxycarbonyl-7,8-dimethoxy-2H-naphtho[1,2-b]pyran;
(b) 2-(4-methylphenyl)-2-phenyl-5-methoxycarbonyl-7,8-dimethoxy-2H-naphtho[1,2-b]pyran;
(c) 2,2-diphenyl-5-methoxycarbonyl-7,8-dimethoxy-2H-naphtho[1,2-b]pyran;
(d) 2-(2-(9,9-dimethyl)-fluorenyl)-2-phenyl-5-methoxycarbonyl-7,8-dimethoxy-2H-naphtho[1,2-b]pyran;
(e) 2,2-diphenyl-5-[2-(2-hydroxyethoxy)ethoxycarbonyl]-7,8-dimethoxy-2H-naphtho[1,2-b]pyran; and
(f) 2,2-diphenyl-5-[2-(2-(2-methacryloxyethyl)carbamyloxyethoxy)-ethoxycarbonyl]-7,8-dimethoxy-2H-naphtho[1,2-b]pyran.

7. A photochromic article comprising a substrate and a photochromic amount of the naphthopyran of claim 1.

8. The photochromic article of claim 7 wherein said substrate is a polymeric material and said photochromic amount of naphthopyran is incorporated into at least a portion of said polymeric material.

9. The photochromic article of claim 8, wherein the polymeric material is polyacrylates, polymethacrylates, poly(C₁-C₁₂) alkylated methacrylates, polyoxy(alkylene methacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), poly(vinylpyrrolidone), poly((meth)acrylamide), poly(dimethyl acrylamide), poly((meth) acrylic acid), thermoplastic polycarbonates, polyesters, polyurethanes, polyureaurethanes, polythiourethanes, poly(ethylene terephthalate), polystyrene, poly(alpha methylstyrene), copoly(styrene-methylmethacrylate), copoly(styrene-acrylonitrile), polyvinylbutyral, and polymers of at least one of polyol(allyl carbonate) monomers, mono-functional acrylate monomers, mono-functional methacrylate monomers, polyfunctional acrylate monomers, polyfunctional methacrylate monomers, diethylene glycol dimethacrylate monomers, diisopropenyl benzene monomers, alkoxylated polyhydric alcohol monomers, and diallylidene pentaerythritol monomers.

10. The photochromic article of claim 9, wherein the polymeric material is an acrylate, a methacrylate, methyl methacrylate, ethylene glycol bis methacrylate, ethoxylated bisphenol A dimethacrylate, vinyl acetate, vinylbutyral, urethane, thiourethane, diethylene glycol, bis(allyl carbonate), diethylene glycol dimethacrylate, diisopropenyl benzene, ethoxylated trimethylol propane triacrylate and combinations thereof.

11. The photochromic article of claim 8 further comprising at least one of a complementary photochromic material, a photoinitiator, a thermal initiator, a polymerization inhibitor, a solvent, a light stabilizer, a heat stabilizer, a mold release agent, a rheology control agent, a leveling agent and a free radical scavenger.

12. The photochromic article of claim 7 wherein said photochromic amount of naphthopyran is connected to at least a portion of said substrate.

13. The photochromic article of claim 12 wherein the photochromic article is an optical element, said optical element being at least one of an ophthalmic element, a display element, a window, a mirror, an active liquid crystal cell element, and a passive liquid crystal cell element.

14. The photochromic article of claim 13 wherein the photochromic article is an ophthalmic element, said ophthalmic element being at least one of a corrective lens, a non-corrective lens, a magnifying lens, a protective lens, a visor, goggles, and a lens for an optical instrument.

15. The photochromic article of claim 12- wherein the substrate comprises a polymeric material and said photochromic amount of naphthopyran is at least one of: blended with at least a portion of the polymeric material of the substrate; and bonded to at least a portion of the polymeric material of the substrate.

16. The photochromic article of claim 15 wherein said photochromic amount of naphthopyran is bonded by co-polymerization to at least a portion of the polymeric material of the substrate.

17. The photochromic article of claim 12 wherein an at least partial coating or film of a polymeric material is connected to at least a portion of a surface of the substrate and the polymeric material comprises said photochromic amount of naphthopyran.

18. The photochromic article of claim 17 wherein said partial coating or film of polymeric material further comprises at least one of a complementary photochromic material, a photoinitiator, a thermal initiator, a polymerization inhibitor, a solvent, a light stabilizer, a heat stabilizer, a mold release agent, a rheology control agent, a leveling agent, a free radical scavenger, and an adhesion promoter.

19. The photochromic article of claim 17 further comprising an at least partial coating or film connected to at least a portion of the substrate, the at least partial coating or film being at least one of a primer coating or film, a protective coating or film, an anti-reflective coating or film and a polarizing coating or film.
